(19) United States
(12) Patent Application Publication
(10) Pub. No.: US 2015/0208092 A1
(43) Pub. Date: Jul. 23, 2015

(54) METHOD AND APPARATUS FOR ENCODING SCALABLE VIDEO, AND METHOD AND APPARATUS FOR DECODING SCALABLE VIDEO

(71) Applicant: SAMSUNG ELECTRONICS CO., LTD., Suwon-si (KR)

(72) Inventors: Tammy Lee, Seoul (KR); Junghye Min, Yongin-si (KR)

(73) Assignee: SAMSUNG ELECTRONICS CO., LTD., Suwon-si (KR)

(21) Appl. No.: 14/411,586

(22) PCT Filed: Jun. 29, 2012
(86) PCT No.: PCT/KR2013/005825

§ 371 Date: Dec. 29, 2014

Related U.S. Application Data
(60) Provisional application No. 61/666,656, filed on Jun. 29, 2012.

(51) Int. Cl. H04N 19/61; H04N 19/176; H04N 19/50; H04N 19/31; H04N 19/103

(52) U.S. Cl. CPC H04N 19/61; H04N 19/31; H04N 19/103; H04N 19/50; H04N 19/176

(57) ABSTRACT

A scalable video encoding method includes determining whether to encode a higher layer image by referring to a reconstructed lower layer image for a data unit, the reconstructed lower layer image being at a lower layer than the higher layer image, adding a flag indicating whether to encode the higher layer image to an encoded bitstream of the higher layer image based on a result of the determining, and determining whether to signal a prediction mode, a partition size, and prediction information based on a value of the flag.

### CROSS-REFERENCE TO RELATED APPLICATIONS

This application is a National Stage Entry of PCT/KR2013/005825, filed on Jul. 1, 2013, which claims priority to U.S. provisional patent application No. 61/666,656, filed on Jun. 29, 2012 in the U.S. Patent and Trademark Office, the entire disclosures of which are incorporated herein by reference in their entirety.

### TECHNICAL FIELD

The exemplary embodiments relate to video encoding and decoding that involves transformation or inverse transformation.

### BACKGROUND OF THE RELATED ART

As hardware for reproducing and storing high resolution or high quality video content is being developed and supplied, a need for a video codec for effectively encoding or decoding the high resolution or high quality video content is increasing. In a conventional video codec, a video is encoded according to a limited encoding method based on a macroblock having a predetermined size.

Image data in a spatial domain is transformed into coefficients of a frequency domain by using frequency transformation. Video codec splits an image into blocks of predetermined sizes, performs discrete cosine transformation (DCT) on each of the blocks, and encodes frequency coefficients of block units to facilitate quick arithmetic operations of the frequency transformation. The coefficients of the frequency domain have easily compressible forms compared to those of the image data in the spatial domain. In particular, an image pixel value of the spatial domain is expressed as a prediction error through an inter prediction or an intra prediction of the video codec, and thus, a large amount of data may be transformed to 0 if the frequency transformation is performed on the prediction error. The video codec replaces continuously and repeatedly generated data into data of a small size, thereby reducing an overall amount of data.

### SUMMARY

The exemplary embodiments provide methods and apparatuses for encoding and decoding a higher layer image by referring to a reconstructed image of a lower layer image.

According to an aspect of an exemplary embodiment, there is provided a scalable video encoding method including determining whether to encode a higher layer image by referring to a reconstructed lower layer image for a data unit, the reconstructed lower layer image being at a lower layer than the higher layer image; adding a flag indicating whether to encode the higher layer image to an encoded bitstream of the higher layer image based on a result of the determining; and determining whether to signal a prediction mode, a partition size, and prediction information based on a value of the flag.

The determining of whether to encode the higher layer image includes: determining an inter-layer intra prediction method configured to predict and encode the higher layer image by referring to the reconstructed lower layer image, and the scalable video encoding method further includes: setting the inter-layer intra prediction method as a part of an inter mode or an intra mode; and generating and signaling prediction information to predict the higher layer image according to the inter-layer intra prediction method that is set as the part of the inter mode or the intra mode.

The method may further include determining an intensity of a deblocking filter of the data unit based on whether the data unit is encoded by referring to the reconstructed lower layer image.

The method may further include determining a context model that is a probability model used to perform binary arithmetic encoding of a syntax element related to a current encoding block in the higher layer image based on a number of times the current encoding block is spatially split from a maximum coding unit.

The method may further include obtaining an offset value of a current coding unit, up-sampling the reconstructed lower layer image including a region corresponding to the current coding unit, shifting the region of the up-sampled lower layer image by using the obtained offset value, obtaining a reconstructed lower layer image of the shifted region, and encoding the current coding unit by referring to the obtained reconstructed lower layer image.

The method may further include generating a skip flag or an inter-layer intra prediction skip flag, determining a signaling order of the generated skip flag or the generated inter-layer intra prediction skip flag, adding the generated skip flag or the generated inter-layer intra prediction skip flag to the encoded bitstream of the higher layer image based on the determined signaling order, and generating an inter-layer intra prediction flag and adding the generated inter-layer intra prediction flag to the encoded bitstream of the higher layer image based on a value of the generated inter-layer intra prediction flag.

According to another aspect of an exemplary embodiment, there is provide a scalable video decoding method including: obtaining a flag indicating whether to decode a higher layer image by referring to a reconstructed lower layer image for a data unit, the reconstructed lower layer image being at a lower layer than the higher layer image, so as to decode the higher layer image; determining whether to decode the higher layer image based on a value of the obtained flag; decoding the higher layer image based on a result of the determining, wherein the decoding of the higher layer image includes obtaining a prediction mode, a partition size, and prediction information for the data unit based on the value of the obtained flag.

The determining of whether to decode the higher layer image includes determining an inter-layer intra prediction method configured to predict and encode the higher layer image by referring to the reconstructed lower layer image based on the value of the obtained flag, and the decoding of the higher layer image includes: setting the inter-layer intra prediction method as a part of an inter mode or an intra mode; and obtaining prediction information to predict the higher layer image according to the inter-layer intra prediction method that is set as the part of the inter mode or the intra mode.

The decoding of the higher layer image may include determining an intensity of a de-blocking filter of the data unit based on whether to perform decoding on the data unit by referring to the reconstructed lower layer image.

The decoding of the higher layer image may include determining a context model that is a probability model used to perform binary arithmetic encoding of a syntax element related to a current encoding block in the higher layer image based on a number of times the current encoding block is spatially split from a maximum coding unit.

The decoding of the higher layer image comprises obtaining an offset value of a current coding unit; up-sampling the reconstructed lower layer image including a region corresponding to the current coding unit; shifting the region of the up-sampled lower layer image by using the obtained offset value; obtaining a reconstructed lower layer image of the shifted region; and decoding the current coding unit by referring to the obtained reconstructed lower layer image.

The method may further include generating a skip flag or an inter-layer intra prediction skip flag, and obtaining an inter-layer intra prediction flag based on a value of the obtained skip flag or the obtained inter-layer intra prediction skip flag, wherein the determining of whether to decode the higher layer image includes determining whether to decode the higher layer image based on a value of the obtained inter-layer intra prediction flag.

According to another aspect of an exemplary embodiment, there is provided a scalable video encoding apparatus including: a lower layer encoder configured to encode a lower layer image; a higher layer encoder configured to determine whether to encode a higher layer image that is at a higher layer than the lower image by referring to a reconstructed lower layer image for a data unit and thereby generate a determination result, encode the higher layer image based on the determination result, add a flag indicating whether to encode the higher layer image to an encoded bitstream of the higher layer image based on the determination result, and determine whether to signal prediction information to predict between images of the same layer as the higher layer image for the data unit or prediction information to predict and encode within the higher layer image; and an outputter configured to output encoded data of the lower layer image or the higher layer image, the generated flag, and the prediction information, wherein the data unit comprises at least one of a maximum coding unit, a coding unit, and a prediction unit.

According to another aspect of an exemplary embodiment, there is provided a scalable video decoding apparatus including: a parser configured to parse a flag indicating whether to decode a higher layer image by referring to a reconstructed lower layer image for a data unit, the reconstructed lower layer image being at a lower layer than the higher layer image, and encode data of the reconstructed lower layer image from a received bitstream, so as to decode the higher layer image; a lower layer decoder configured to decode the reconstructed lower layer image; and a higher layer decoder configured to determine whether to decode the higher layer image by referring to the reconstructed lower layer image for the data unit based on a value of the parsed flag, and decode the higher layer image, wherein the higher layer decoder is configured to obtain prediction information to predict between images of the same layer as the higher layer image for the data unit or prediction information to predict and encode within the higher layer image based on the value of the parsed flag.

According to another aspect of an exemplary embodiment, there is provided a non-transitory computer-readable recording medium having recorded thereon a program which, when executed, causes a computer to perform the method according to exemplary embodiments.

When a data unit flexibly changes, a higher layer image may be encoded and decoded by referring to a reconstructed image of a lower layer image.

### BRIEF DESCRIPTION OF THE DRAWINGS

FIG. 1 is a block diagram of a scalable video encoding apparatus according to an exemplary embodiment;

FIG. 2 is a block diagram of a scalable video decoding apparatus according to an exemplary embodiment;

FIG. 3 is a block diagram of a scalable video encoding system, according to an exemplary embodiment;

FIGS. 4 and 5 are diagrams for describing a relationship between coding units and prediction units, according to an exemplary embodiment;

FIG. 6 is a diagram for explaining an inter-layer prediction method, according to an exemplary embodiment;

FIG. 7 is a diagram for explaining a mapping relationship between a lower layer and a higher layer, according to an exemplary embodiment;

FIG. 8 is a diagram for explaining inter-layer intra prediction, according to an exemplary embodiment;

FIGS. 9 and 10 are flowcharts of a scalable video encoding method, according to exemplary embodiments;

FIG. 11 is a flowchart of a method of signaling a flag or prediction information, according to an exemplary embodiment;

FIG. 12 is a diagram for explaining signaling of a flag or prediction information, according to an exemplary embodiment;

FIGS. 13 and 14 are flowcharts of a scalable video decoding method, according to an exemplary embodiment; and

FIG. 15 is a flowchart of a method of obtaining a signaled flag or prediction information, according to an exemplary embodiment.

### DETAILED DESCRIPTION OF EXEMPLARY EMBODIMENTS

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the exemplary embodiments.

The terms used in the present specification and claims should not be limitedly interpreted by common or dictionary meanings but should be interpreted to be suitable for the scope of the exemplary embodiments based on the principle that the inventor may appropriately define his or her exemplary embodiments by optimal terms. It should be understood, however, that there is no intent to limit exemplary embodiments to the particular forms disclosed, but conversely, exemplary embodiments are to cover all modifications, equivalents, and alternatives falling within the spirit and scope of the exemplary embodiments.

As used herein, the term “an exemplary embodiment” or “exemplary embodiments” refers to properties, structures, features, and the like, that are described in relation to an exemplary embodiment that is included in at least one exemplary embodiment. Thus, expressions such as “according to an exemplary embodiment” do not always refer to the same exemplary embodiment.

The term ‘image’ used through the exemplary embodiments may be used for describing various forms of video image information such as a ‘frame’, a ‘field’, and a ‘slice’.

Hereinafter, exemplary embodiments will be described with reference to the accompanying drawings.

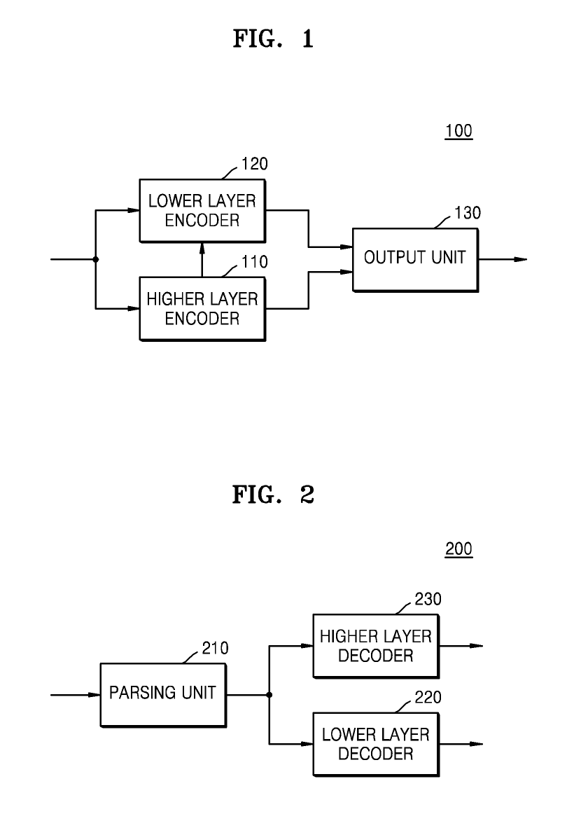

FIG. 1 is a block diagram of a scalable video encoding apparatus 100 according to an exemplary embodiment.

Referring to FIG. 1, the scalable video encoding apparatus 100 according to an exemplary embodiment includes a lower layer encoder 110, a higher layer encoder 120, and an output unit 130 (e.g., outputter).

The lower layer encoder 110 according to an exemplary embodiment may encode a lower layer image among images classified as a plurality of layers.

The lower layer encoder 110 may transmit encoded data with respect to a lower layer image region corresponding to a block of an encoded higher layer image to the higher layer encoder 120. Alternatively, the lower layer encoder 110 may transmit data of a reconstructed image with respect to the corresponding lower layer image region to the higher layer encoder 120. The reconstructed image data with respect to the lower layer image region may be up-sampled and then referred to when the block of the higher layer image corresponding to the lower layer image region is encoded.

The higher layer encoder 120 may encode a higher layer image among the images classified as the plurality of layers. The higher layer encoder 120 may obtain a reconstructed image of a block of the lower layer image corresponding to the encoded block from the lower layer encoder 110 so as to encode the higher layer image in a data unit. The higher layer encoder 120 may encode the higher layer image in the data unit by referring to the obtained reconstructed image of the lower layer image. In this regard, a region of the lower layer image that may be referred to may be a region encoded according to an intra prediction mode in which a reference image is not necessarily reconstructed.

The higher layer encoder 120 according to an exemplary embodiment may determine whether to encode the higher layer image according to an inter-layer intra prediction method for a predetermined data unit of the higher layer image. According to the inter-layer intra prediction method, a reconstructed image of a partial or whole region of the lower layer image may be up-sampled, and the up-sampled image may be referred to for encoding the higher layer image. In this regard, a region of the lower layer image that may be referred to may be a region encoded according to the intra prediction mode. For example, the higher layer encoder 120 may determine whether to encode the higher layer image according to the inter-layer intra prediction method individually for each of maximum coding units. For example, the higher layer encoder 120 may determine whether to encode the higher layer image according to the inter-layer intra prediction method individually for each of coding units. For example, the higher layer encoder 120 may determine whether to encode the higher layer image according to the inter-layer intra prediction method individually for each of prediction units. For example, the higher layer encoder 120 may determine whether to encode the higher layer image according to the inter-layer intra prediction method individually for each of predetermined groups of the coding units.

That is, the higher layer encoder 120 according to an exemplary embodiment may perform prediction encoding according to the inter-layer intra prediction method that encodes the higher layer image by referring to the lower layer image for each of data units or may perform prediction encoding according to a prediction method other than the inter-layer intra prediction method.

According to an exemplary embodiment, a prediction encoding method that may be determined for each data unit may be determined based on a rate distortion cost for determining better encoding efficiency. In this regard, the prediction encoding method that may be determined based on the encoding efficiency may include at least one of an intra prediction method, an inter prediction mode, an intra prediction mode, and a skip mode.

The inter prediction mode may refer to an inter-screen prediction mode. The intra prediction mode may refer to an intra-screen prediction mode. In the skip mode, prediction encoding may not be performed, and a flag indicating a current data unit is encoded in the skip mode may be generated. In the skip mode, a scalable video decoding apparatus 200 may decode the current data unit by using a data unit of a previous reconstructed image corresponding to the current data unit. For example, pixel values of a data unit of a previous image may be determined as pixel values of the corresponding current data unit. The previous image may be an image having a value preceding that of a current image with respect to a picture order count (POC) value.

The output unit 130 may output data of the encoded lower layer image or higher layer image according to an encoding result of the lower layer encoder 110 or the higher layer encoder 120.

The output unit 130 according to an exemplary embodiment may output an encoding mode of the lower layer image and a predicted value of the lower layer image.

The output unit 130 according to an exemplary embodiment may output different information for the higher layer image according to whether to encode the higher layer image according to the inter-layer intra prediction method.

For example, the higher layer encoder 120 may predict the higher layer image by referring to a reconstructed image of the lower layer image according to the inter-layer intra prediction method of the higher layer image. Alternatively, the higher layer encoder 120 may predict a part of the higher layer image by referring to the reconstructed image of the lower layer image according to the inter-layer intra prediction method of the higher layer image.

The higher layer encoder 120 according to an exemplary embodiment may determine a data unit of the lower layer image that may be referred to by a data unit of the higher layer image. In other words, a lower layer data unit mapped to a location corresponding to a location of a higher layer data unit may be determined. The higher layer encoder 120 may predict and encode the higher layer image by referring to reconstructed data of the determined data unit of the lower layer image.

The data units of the lower layer image and the higher layer image may include at least one of the maximum coding unit of each of the higher and lower layer images, the coding unit, and the prediction unit included in the coding unit.

The higher layer encoder 120 according to an exemplary embodiment may determine the data unit of the lower layer image having the same type as a type of a current data unit of the higher layer image. For example, the maximum coding unit of the higher layer image may refer to the maximum coding unit of the lower layer image. The coding unit of the higher layer image may refer to the coding unit of the lower layer image.

The higher layer encoder 120 according to an exemplary embodiment may determine a data unit group of the lower layer image having the same group type as a group type of a current data unit group of the higher layer image. For example, a group of the coding unit of the higher layer image may refer to a group of the coding unit of the lower layer image. A group of the prediction unit of the higher layer image may refer to a group of the prediction unit of the lower layer image.

An exemplary embodiment related to mapping of the data units between the lower and higher layer images will be described with reference to FIG. 7 later.

The higher layer encoder 120 may determine a data unit corresponding to the current data unit of the higher layer image and having a different type from a type of a current data unit group from among data unit groups of the lower layer image. For example, the coding unit of the higher layer image may refer to the maximum coding unit of the lower layer image. The prediction unit of the higher layer image may refer to the coding unit of the lower layer image. The current data unit of the higher layer image may be encoded by referring to the reconstructed data of the data unit of the lower layer image.

The higher layer encoder 120 may determine a data unit group corresponding to the current data unit group of the higher layer image and having a different type from a type of the current data unit group from among data unit groups of the lower layer image. For example, a group of prediction units of the higher layer image may refer to a group of the coding units of the lower layer image. A group of transformation units of the higher layer image may refer to a group of the coding units of the lower layer image. The current data unit group of the higher layer image may be encoded by referring to reconstructed data of a data unit group that is different from that of the lower layer image.

In a case where whether to encode the higher layer image is determined according to the inter-layer intra prediction method for the current data unit of the higher layer image, the higher layer encoder 120 may perform prediction encoding according to the inter-layer intra prediction method that predicts and encodes a part of lower data units included in the current data unit by referring to the lower layer image, and may perform prediction encoding of the remaining part of the lower data units within the same layer as the higher layer image.

The scalable video encoding apparatus 100 according to an exemplary embodiment may include a central processor (not shown) that generally controls the lower layer encoder 110, the higher layer decoder 120, and the output unit 130. Alternatively, the lower layer encoder 110, the higher layer decoder 120, and the output unit 130 may be operated by their respective processors (not shown), and the scalable video encoding apparatus 100 may generally operate according to interactions of the processors (not shown). Alternatively, the lower layer encoder 110, the higher layer decoder 120, and the output unit 130 may be controlled according to the control of an external processor (not shown) of the scalable video encoding apparatus 100.

The scalable video encoding apparatus 100 according to an exemplary embodiment may include one or more data storage units (not shown) in which input and output data of the lower layer encoder 110, the higher layer decoder 120, and the output unit 130 is stored. The video encoding apparatus 100 may include a memory control unit (not shown) that controls data input and output of the data storage units (not shown).

The scalable video encoding apparatus 100 according to an exemplary embodiment may operate in connection with an internal video encoding processor or an external video encoding processor so as to output video encoding results, thereby performing a video encoding operation including transformation. The internal video encoding processor of the scalable video encoding apparatus 100 according to an exemplary embodiment may be implemented by a central processor or a graphic processor as well as a separate processor.

FIG. 2 is a block diagram of a scalable video decoding apparatus 200 according to an exemplary embodiment.

Referring to FIG. 2, the scalable video decoding apparatus 200 according to an exemplary embodiment may include a parsing unit 210 (e.g., parser), a lower layer decoder 220, and a higher layer decoder 230.

The scalable video decoding apparatus 200 may receive a bitstream storing encoded video data. The parsing unit 210 may parse encoded data of a lower layer image and a flag indicating whether to decode a higher layer image by referring to a lower layer image reconstructed for each of data units from the received bitstream.

The lower layer decoder 220 may decode the lower layer image by using the parsed encoded data of the lower layer image.

The higher layer decoder 230 may predict and decode the higher layer image by referring to the encoded data of the lower layer image according to a value of the parsed flag. That is, the higher layer decoder 230 may predict and decode the higher layer image by referring to reconstructed data of the lower layer image.

The higher layer decoder 230 may determine a data unit of the lower layer image that may be referred to by a data unit by the higher layer image according to the value of the flag parsed from the bitstream. That is, the data unit of the lower layer image mapped to a location corresponding to a location of the data unit of the higher layer image may be determined. The higher layer decoder 230 may predict and decode the higher layer image by referring to encoded data of the determined data unit of the lower layer image. The higher layer image may be predicted and decoded based on coding units having a tree structure.

The higher layer decoder 230 may determine the data unit of the lower layer image having the corresponding same type as a type of a current data unit of the higher layer image. The higher layer decoder 230 may decode the current data unit by referring to the encoded data of the determined data unit of the lower layer image.

The higher layer decoder 230 may determine a data unit group of the lower layer image having the corresponding same group type as a current data unit group of the higher layer image. The higher layer decoder 230 may determine encoding information of the current data unit group of the higher layer image by referring to encoding information of the determined data unit group of the lower layer image and decode the current data unit group by using the encoding information of the current data unit group.

The higher layer decoder 230 may determine a data unit of the lower layer image having a corresponding different type from a type of the current data unit of the higher layer image and determine encoding information of the current data unit of the higher layer image by referring to the encoding information of the data unit of the lower layer image. For example, encoding information of a current maximum coding unit of the higher layer image may be determined by using encoding information of a predetermined coding unit of the lower layer image.

The higher layer decoder 230 may determine a data unit group of the lower layer image having a corresponding different type from a type of a current data unit group of the higher layer image and determine encoding information of the current data unit group of the higher layer image by referring to encoding information of the data unit group of the lower layer image. For example, encoding information of a current maximum coding unit group of the higher layer image may be determined by using encoding information of a predetermined coding unit group of the lower layer image.

In a case where whether to decode the higher layer image according to an inter-layer intra prediction method for data units of the higher layer image is determined according to the flag value, the higher layer decoder 230 may decode a part of lower data units included in the current data unit by referring to the lower layer image and decode the remaining part of the lower data units within the same layer as the higher layer image.

The scalable video decoding apparatus 200 according to an exemplary embodiment may include a central processor (not shown) that generally controls the parsing unit 210, the lower layer decoder 220, and the higher layer decoder 230. Alternatively, the parsing unit 210, the lower layer decoder 220, and the higher layer decoder 230 may be operated by their respective processors (not shown), and the scalable video decoding apparatus 200 may generally operate according to interactions of the processors (not shown). Alternatively, the parsing unit 210, the lower layer decoder 220, and the higher layer decoder 230 may be controlled according to the control of an external processor (not shown) of the scalable video decoding apparatus 200.

The scalable video decoding apparatus 200 according to an exemplary embodiment may include one or more data storage units (not shown) in which input and output data of the parsing unit 210, the lower layer decoder 220, and the higher layer decoder 230 are stored. The scalable video decoding apparatus 200 may include a memory control unit (not shown) that controls data input and output of the data storage units (not shown).

The scalable video decoding apparatus 200 according to an exemplary embodiment may operate in connection with an internal video encoding processor or an external video encoding processor so as to restore video through video decoding, thereby performing a video decoding operation including inverse transformation. The internal video encoding processor of the scalable video decoding apparatus 200 according to an exemplary embodiment may be implemented by a central processor or a graphic processor as well as a separate processor.

The scalable video encoding apparatus 100 and the scalable video decoding apparatus 200 according to an exemplary embodiment may determine whether to perform encoding and decoding according to the inter-layer intra prediction method for each sequence, slice, or picture.

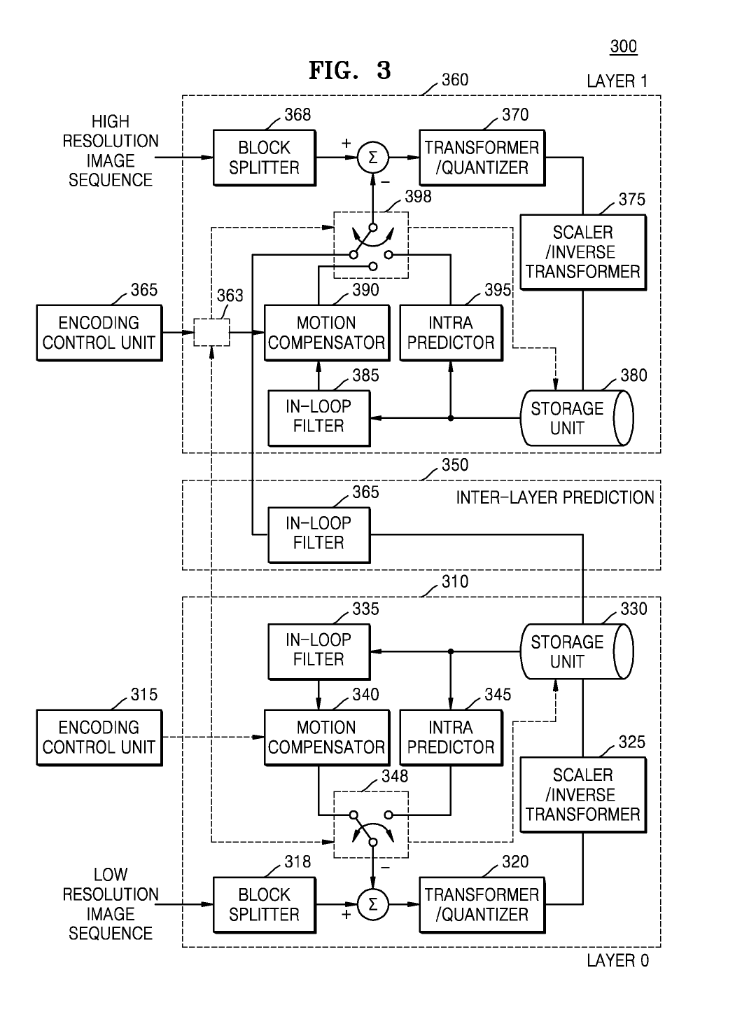

FIG. 3 is a block diagram of a scalable video encoding system 300 according to an exemplary embodiment.

The scalable video encoding system 300 may include a lower layer encoding end 310, a higher layer encoding end 360, and an inter-layer prediction end 350 between the lower layer encoding end 310 and the higher layer encoding end 360. The lower layer encoding end 310 and the higher layer encoding end 360 may illustrate detailed structures of the lower layer encoder 110 and the higher layer encoder 120, respectively.

A scalable video encoding method may classify multilayer images according to a temporal characteristic and a quality characteristic such as image quality, as well as a spatial characteristic such as resolution. For convenience of description, a case where the scalable video encoding system 300 separately encodes a low resolution image to a lower layer image and a high resolution image to a higher layer image according to image resolution will now be described.

The lower layer encoding end 310 receives an input of a low resolution image sequence and encodes each low resolution image of the low resolution image sequence. The higher layer encoding end 360 receives an input of a high resolution image sequence and encodes each high resolution image of the high resolution image sequence. Common operations performed by both the lower layer encoding end 310 and the higher layer encoding end 360 will be concurrently described later.

Block splitters 318 and 368 split the input images (the low resolution image and the high resolution image) into maximum coding units, coding units, prediction units, and transformation units. To encode the coding units output from the block splitters 318 and 368, intra prediction or inter prediction may be performed for each prediction unit of the coding units. Prediction switches 348 and 398 may perform inter prediction by referring to a previously reconstructed image output from motion compensators 340 and 390 or may perform intra prediction by using a neighboring prediction unit of a current prediction unit within a current input image output from intra predictors 345 and 395, according to whether a prediction mode of each prediction unit is an intra prediction mode or an inter prediction mode. Residual information may be generated for each prediction unit through inter prediction.

Residual information between the prediction units and peripheral images are input to transformers/quantizers 320 and 370 for each prediction unit of the coding units. The transformers/quantizers 320 and 370 may perform transformation and quantization for each transformation unit and output quantized transformation coefficients based on transformation units of the coding units.

Scalers/inverse transformers 325 and 375 may perform scaling and inverse transformation on the quantized coefficients for each transformation unit of the coding units again and generate residual information of a spatial domain. In a case where the prediction switches 348 and 398 are controlled to the inter mode, the residual information may be combined with the previous reconstructed image or the neighboring prediction unit so that a reconstructed image including the current prediction unit may be generated and a current reconstructed image may be stored in storage units 330 and 380. The current reconstructed image may be transferred to the intra predictors 1645 and 1695 and the motion compensators 340 and 390 again according to a prediction mode of a prediction unit that is to be encoded next.

In particular, in the inter mode, in-loop filters 335 and 385 may perform at least one of deblocking filtering, sample adaptive offset (SAO) operation, and adaptive loop filtering (ALF) on the current reconstructed image stored in the storage units 330 and 380 for each coding unit. At least one of the deblocking filtering, the SAO operation, and the ALF filtering may be performed on at least one of the coding units, the prediction units included in the coding units, and the transformation units.

The deblocking filtering is filtering for reducing blocking artifacts of data units. The SAO operation is filtering for compensating for a pixel value modified by data encoding and decoding. The ALF filtering is filtering for minimizing a mean squared error (MSE) between a reconstructed image and an original image. Data filtered by the in-loop filters 335 and 385 may be transferred to the motion compensators 340 and 390 for each prediction unit. To encode the coding unit having a next sequence that is output from the block splitters 318 and 368 again, residual information between the current reconstructed image and the next coding unit that are output from the motion compensators 318 and 368 and the block splitters 318 and 368 may be generated.

The above-described encoding operation for each coding unit of the input images may be repeatedly performed in the same manner as described above.

The higher layer encoding end 360 may refer to the reconstructed image stored in the storage unit 330 of the lower layer encoding end 310 for the inter-layer prediction. An encoding control unit 315 of the lower layer encoding end 310 may control the storage unit 330 of the lower layer encoding end 310 and transfer the reconstructed image of the lower layer encoding end 310 to the higher layer encoding end 360. The in-loop filter 335 of the inter-layer prediction end 350 may perform at least one filtering of the deblocking filtering, the SAO filtering, and the ALF filtering on a lower layer reconstructed image output from the storage unit 330 of the lower layer encoding end 310. In a case where a lower layer image and a higher layer image have different resolutions, the inter-layer prediction end 350 may up-sample and transfer a lower layer reconstructed image to the higher layer encoding end 360. In a case where inter-layer prediction is performed according to control of the prediction switch 398 of the higher layer encoding end 360, inter-layer prediction of the higher layer image may be performed by referring to the lower layer reconstructed image transferred through the inter-layer prediction end 350.

For image encoding, diverse coding modes may be set for the coding units, prediction units, and transformation units. For example, a depth or a split flag may be set as a coding mode for the coding units. A prediction mode, a partition type, an intra direction flag, a reference list flag, a motion vector, a reference index, etc., may be set as a coding mode for the prediction units. The transformation depth or the split flag may be set as a coding mode of the transformation units.

The lower layer encoding end 310 may determine a coding depth, a prediction mode, a partition type, an intra direction and reference list, a motion vector, a reference index, and a transformation depth having the highest coding efficiency according to a result obtained by performing encoding by applying diverse depths for the coding units, diverse prediction modes for the prediction units, diverse partition types, diverse intra directions, diverse reference lists, and diverse transformation depths for the transformation units. However, the exemplary embodiments are not limited to the above-described coding modes determined by the lower layer encoding end 310.

The encoding control unit 315 (e.g., encoding controller) of the lower layer encoding end 310 may control diverse coding modes to be appropriately applied to operations of elements. For scalable video encoding of the higher layer encoding end 360, the encoding control unit 315 may control the higher layer encoding end 360 to determine a coding mode or residual information by referring to the encoding result of the lower layer encoding end 310.

For example, the higher layer encoding end 360 may use the coding mode of the lower layer encoding end 310 as a coding mode of the higher layer image or may determine the coding mode of the higher layer image by referring to the coding mode of the lower layer encoding end 310. The encoding control unit 315 of the lower layer encoding end 310 may control a control signal of the encoding control unit 315 of the lower layer encoding end 310 and, to determine a current coding mode of the higher layer encoding end 360, may use the current coding mode based on the coding mode of the lower layer encoding end 310.

Similarly to the scalable video encoding system 300 according to the inter-layer prediction method of FIG. 3, a scalable video decoding system according to the inter-layer prediction method may be also implemented. That is, the scalable video decoding system may receive a lower layer bitstream and a higher layer bitstream. A lower layer decoding end of the scalable video decoding system may decode the lower layer bitstream to generate lower layer reconstructed images. A higher layer decoding end of the scalable video decoding system may decode the higher layer bitstream to generate higher layer reconstructed images.

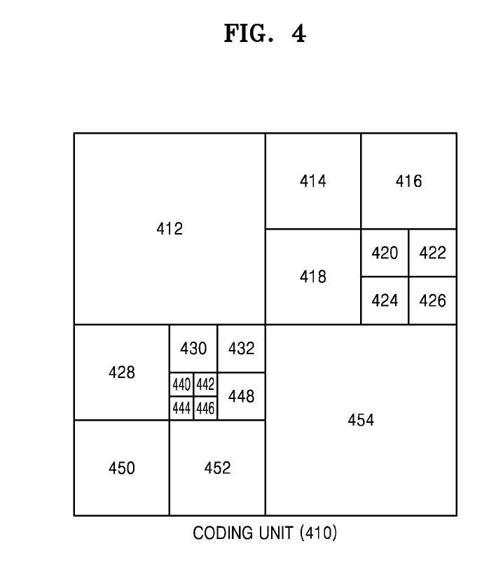

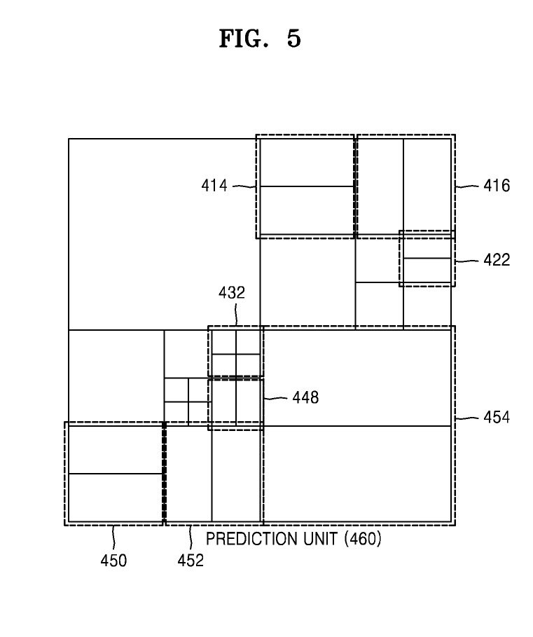

FIGS. 4 and 5 are diagrams for describing a relationship between coding units and prediction units, according to an exemplary embodiment.

The coding units 410 are coding units having a tree structure, corresponding to coded depths determined by the scalable video encoding apparatus 100, in a maximum coding unit. The prediction units 460 are partitions of prediction units of each of the coding units 410.

When a depth of a maximum coding unit is 0 in the coding units 410, depths of coding units 412 and 454 are 1, depths of coding units 414, 416, 418, 428, 450, and 452 are 2, depths of coding units 420, 422, 424, 426, 430, 432, and 448 are 3, and depths of coding units 440, 442, 444, and 446 are 4.

In the prediction units 460, some coding units 414, 416, 422, 432, 448, 450, 452, and 454 are obtained by splitting the coding units in the encoding units 410. In other words, partition types in the coding units 414, 422, 450, and 454 have a size of 2N×N, partition types in the coding units 416, 448, and 452 have a size of N×2N, and a partition type of the coding unit 432 has a size of N×N. Prediction units and partitions of the coding units 410 are smaller than or equal to each coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit.

The output unit 130 of the scalable video encoding apparatus 100 according to an exemplary embodiment may output data indicating whether to perform encoding according to an inter-layer intra prediction method for maximum coding units, coding units, prediction units or transformation units, and the scalable video decoding apparatus 200 according to an exemplary embodiment may extract data indicating whether to perform decoding according to the inter-layer intra prediction method for coding units, prediction units or transformation units from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched for by using encoded information of the data units, and the found adjacent coding units may be referred to for predicting the current coding unit.

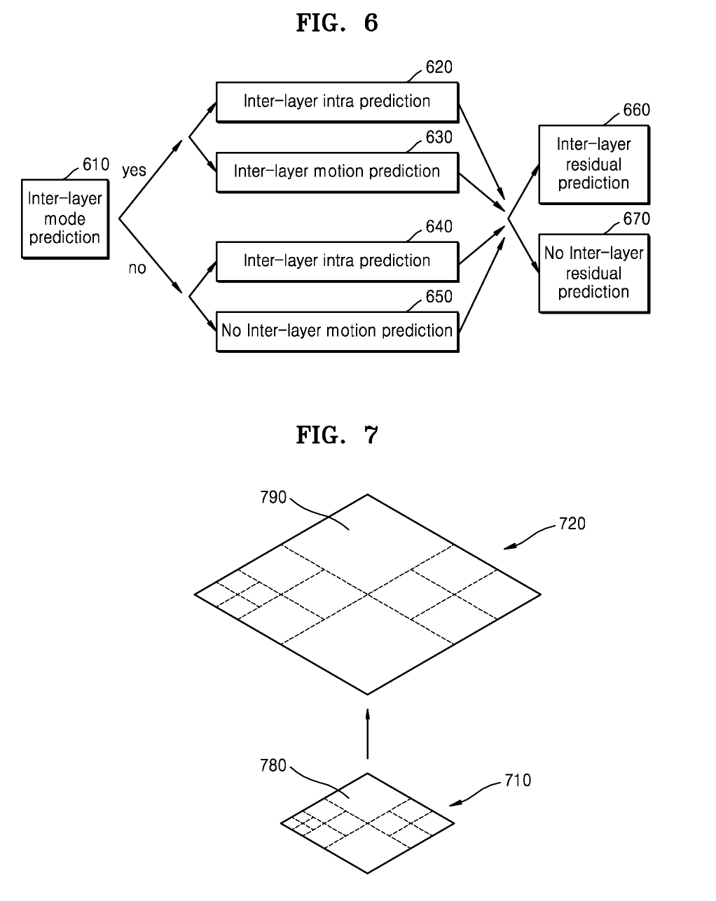

FIG. 6 is a diagram for explaining an inter-layer prediction method according to an exemplary embodiment.

In a case where scalable video encoding for a higher layer image is performed, a coding mode of a lower layer image may be used to set whether to perform inter-layer mode prediction 610 that encodes the higher layer image. If the inter-layer mode prediction 610 is performed, inter-layer intra prediction 620 or first inter-layer motion prediction 630 may be performed. If the inter-layer mode prediction 610 is not performed, second inter-layer motion prediction 640 or prediction 650 other than inter-layer motion prediction (also referred to as “No Inter-layer motion prediction”) may be performed.

In a case where scalable video encoding for the higher layer image is performed, irrespective of whether the inter-layer mode prediction 610 is performed, inter-layer residual prediction 660 or general residual prediction 670 may be performed.

According to the inter-layer residual prediction 660, residual information of the higher layer image may be predicted by referring to residual information of the lower layer image. According to the general residual prediction 670, residual information of a current higher layer image may be predicted by referring to other images of the higher layer image sequence.

For example, according to the inter-layer intra prediction 620, sample values of the higher layer image may be predicted by referring to sample values of a lower layer image corresponding to the higher layer image. According to the first inter-layer motion prediction 630, a partition type of a prediction unit by inter prediction of the lower layer image corresponding to the higher layer image, a reference index, and a motion vector may be applied as an inter mode of the higher layer image. The reference index indicates a sequence referred to by each image in reference images included in the reference list.

For example, according to the second inter-layer motion prediction 640, the coding mode by inter prediction of the lower layer image may be referred to as a coding mode of the higher layer image. For example, although a reference index of the higher layer image may be determined by adopting the reference index of the lower layer image, a motion vector of the higher layer image may be predicted by referring to the motion vector of the lower layer image.

For example, according to the prediction 650 other than the inter-layer motion prediction, irrespective of an encoding result of the lower layer image, motion prediction for the higher layer image may be performed by referring to other images of a higher layer image sequence.

In a case where scalable video encoding for the higher layer image is performed, irrespective of whether the inter-layer mode prediction 610 is performed, the inter-layer residual prediction 660 or the general residual prediction 670 may be performed.

According to the inter-layer residual prediction 660, residual information of the higher layer image may be predicted by referring to residual information of the lower layer image. According to the general residual prediction 670, residual information of a current higher layer image may be predicted by referring to other images of the higher layer image sequence.

As described with reference to FIG. 6, for scalable video encoding of the higher layer image, inter-layer prediction between the lower layer image and the higher layer image may be performed. According to the inter-layer prediction, inter-layer mode prediction that determines the coding mode of the higher layer image by using the coding mode of the lower layer image, inter-layer residual prediction that determines the residual information of the higher layer image by using the residual information of the lower layer image, and inter-layer intra prediction that encodes the higher layer image with prediction by referring to the lower layer image only when the lower layer image is in an intra mode, may be selectively performed.

For each coding unit or prediction unit according to an exemplary embodiment, it may be also determined whether to perform inter-layer mode prediction, inter-layer residual prediction, or inter-layer intra prediction.

As another example, if a reference list for each partition is determined, it may be determined whether to perform inter-layer motion prediction for each reference list.

For example, if a reference list for each partition that is an inter mode is determined, it may be determined whether to perform inter-layer motion prediction for each reference list.

For example, in a case where inter-layer mode prediction is performed on a current coding unit (prediction unit) of the higher layer image, a prediction mode of a coding unit (prediction unit) corresponding to the lower layer image may be determined as a prediction mode of the current coding unit (prediction unit) of the higher layer image.

For convenience of description, the current coding unit (prediction unit) of the higher/lower layer image may be referred to as a higher/lower layer data unit.

That is, when the lower layer data unit is encoded in an intra mode, inter-layer intra prediction may be performed for the higher layer data unit. If the lower layer data unit is encoded in the inter mode, inter-layer motion prediction may be performed for the higher layer data unit.

However, in a case where a lower layer data unit at a location corresponding to the higher layer data unit is encoded in the inter mode, it may be further determined whether to perform inter-layer residual prediction for the higher layer data unit. In a case where the lower layer data unit is encoded in the inter mode and inter-layer residual prediction is performed, residual information of the higher layer data unit may be predicted by using residual information of the lower layer data unit. Although the lower layer data unit is encoded in the inter mode, if inter-layer residual prediction is not performed, the residual information of the higher layer data unit may be determined by motion prediction between higher layer data units by not referring to the residual information of the lower layer data unit.

In a case where inter-layer mode prediction is not performed on the higher layer data unit, the inter-layer prediction method may be determined according to whether a prediction mode of the higher layer data unit is a skip mode, an inter mode, or an intra mode. For example, in a higher layer data unit of the inter mode, it may be determined whether inter-layer motion prediction is performed for each reference list of a partition. In a higher layer data unit of the intra mode, it may be determined whether inter-layer intra prediction is performed.

According to an exemplary embodiment, when the lower layer data unit is encoded in the intra mode, the scalable video encoding apparatus 100 may encode a higher layer image according to an inter-layer intra prediction method by referring to a lower layer image for the higher layer data unit.

It may be selectively determined for each data unit whether inter-layer prediction is performed, inter-layer residual prediction is performed, or inter-layer intra prediction is performed. For example, the scalable video encoding apparatus 100 may previously set whether to perform inter-layer prediction on data units of a current slice for each slice. The scalable video decoding apparatus 200 may determine whether to perform inter-layer prediction on the data units of the current slice for each slice according to whether the scalable video encoding apparatus 100 performs inter-layer prediction.

As another example, the scalable video encoding apparatus 100 may previously set whether to perform inter-layer motion prediction on the data units of the current slice for each slice. The scalable video decoding apparatus 200 may determine whether to perform inter-layer motion prediction on the data units of the current slice for each slice according to whether the scalable video encoding apparatus 100 performs inter-layer motion prediction.

As another example, the scalable video encoding apparatus 100 may previously set whether to perform inter-layer residual prediction on the data units of the current slice for each slice. The scalable video decoding apparatus 200 may determine whether to perform inter-layer residual prediction on the data units of the current slice for each slice according to whether the scalable video encoding apparatus 100 performs inter-layer residual prediction.

A detailed operation of each inter-layer prediction of the higher layer data unit will now be further described below.

The scalable video encoding apparatus 100 may set whether to perform inter-layer mode prediction for each higher layer data unit. In a case where inter-layer mode prediction is performed for each higher layer data unit, only the residual information of the higher layer data unit may be transmitted and the coding mode may not be transmitted.

The scalable video decoding apparatus 200 may determine whether to perform inter-layer mode prediction for each higher layer data unit according to whether the scalable video encoding apparatus 200 performs inter-layer mode prediction for each higher layer data unit. Based on whether inter-layer mode prediction is performed, it may be determined whether to adopt the coding mode of the lower layer data unit as the coding mode of the higher layer data unit. In a case where inter-layer mode prediction is performed, the scalable video decoding apparatus 200 may determine a coding unit of the higher layer data unit by using the coding mode of the lower layer data unit without receiving and reading the coding mode of the higher layer data unit. In this case, the scalable video decoding apparatus 200 may receive and read only the residual information of the higher layer unit.

If the lower layer data unit corresponding to the higher layer data unit is encoded in the intra mode by performing inter-layer mode prediction, the scalable video decoding apparatus 200 may perform inter-layer intra prediction on the higher layer data unit.

Deblocking filtering may be first performed on a reconstructed image of the lower layer data unit in the intra mode.

A part of the reconstructed image corresponding to the higher layer data unit on which deblocking filtering of the lower layer data unit is performed may be up-sampled. For example, a luma component of the higher layer data unit may be up-sampled through 4-tap sampling, and a chroma component thereof may be up-sampled through bilinear filtering.

Up-sampling filtering may be performed across a partition boundary of a prediction unit. However, if intra encoding is not performed on a neighboring data unit, the lower layer data unit may be up-sampled by extending a component of a boundary region of a current data unit to an outside of the boundary region and generating samples to be used for upsampling filtering.

If the lower layer data unit corresponding to the higher layer data unit is encoded in the inter mode by performing inter-layer mode prediction, the scalable video decoding apparatus 200 may perform inter-layer motion prediction on the higher layer data unit.

First, a partition type, a reference index, and a motion vector of the lower layer data unit of the inter mode may be referred to. The corresponding lower layer data unit is up-sampled so that a partition type of the higher layer data unit may be determined. For example, if a size of a lower layer partition is M×N, a partition having a size of 2M×2N on which the lower layer partition is up-sampled may be determined as a higher layer partition.

A reference index of a partition upsampled for the higher layer partition may be determined in the same manner as a reference index of the lower layer partition. A motion vector of the partition upsampled for the higher layer partition may be obtained by expanding a motion vector of the lower layer partition at the same ratio as an upsampling ratio.

The scalable video decoding apparatus 200 may determine whether to perform inter-layer motion prediction on the higher layer data unit without performing inter-layer mode prediction if the higher layer data unit is determined to be the inter mode.

It may be determined whether inter-layer motion prediction is performed for each reference list of the higher layer partition. In a case where inter-layer motion prediction is performed, the scalable video decoding apparatus 200 may determine the reference index and motion vector of the higher layer partition by referring to the corresponding reference index and motion vector of the lower layer partition.

In a case where the higher layer data unit is determined to be the intra mode without performing inter-layer mode prediction, the scalable video decoding apparatus 200 may determine whether to perform inter-layer intra prediction for each partition of the higher layer data unit.

In a case where inter-layer intra prediction is performed, deblocking filtering is performed on the reconstructed image on which the lower layer data unit corresponding to the higher layer data unit is decoded, and upsampling is performed on the deblocking filtered reconstructed image. For example, a 4 tap sampling filter may be used for upsampling of the luma component, and a bilinear filter may be used for upsampling of the chroma component.

A prediction image of the higher layer data unit may be generated by predicting the higher layer data unit in the intra mode by referring to the reconstructed image upsampled from the lower layer data unit. A reconstructed image of the higher layer data unit may be generated by combining the prediction image of the higher layer data unit and a residual image of the higher layer data unit. Deblocking filtering may be performed on the generated reconstructed image.

Inter-layer prediction according to an exemplary embodiment may be restricted to be performed under a specific condition. For example, there may be restricted inter-layer intra prediction that uses the upsampled reconstructed image of the lower layer data unit only when the condition that the lower layer data unit is encoded in the intra mode is satisfied. However, in a case where the above restriction condition is not satisfied or in a case of multi-loop decoding, the scalable video decoding apparatus 200 may completely perform inter-layer intra prediction according to whether the scalable video encoding apparatus 100 performs inter-layer intra prediction.

The scalable video decoding apparatus 200 may determine whether to perform inter-layer residual prediction on the higher layer data unit if the lower layer data unit at the location corresponding to the higher layer data unit is encoded in inter mode. Whether to perform inter-layer residual prediction may be determined irrespective of inter-layer mode prediction.

If the higher layer data unit is a skip mode, since inter-layer residual prediction may not be performed, it is unnecessary to determine whether to perform inter-layer residual prediction. If the scalable video decoding apparatus 200 does not perform inter-layer residual prediction, higher layer images may be used to decode a current higher layer prediction unit in a general inter mode.

In a case where inter-layer residual prediction is performed, the scalable video decoding apparatus 200 may upsample and refer to the residual information of the lower layer data unit for each data unit for the higher layer data unit. For example, residual information of the transformation unit may be upsampled through bilinear filtering.

The residual information upsampled from the lower layer data unit may be combined with a prediction image in which motion is compensated among the higher layer data units to generate a prediction image by inter-layer residual prediction. Thus, a residual image between an original image of the higher layer data unit and the prediction image generated by inter-layer residual prediction may be newly generated. In contrast, the scalable video decoding apparatus 200 may generate the reconstructed image by reading a residual image for inter-layer residual prediction of the higher layer data unit and combining the read residual image, the residual information upsampled from the lower layer data unit, and the prediction image in which motion is compensated among the higher layer data units.

Examples of inter-layer prediction, detailed operations of inter-layer mode prediction of the higher layer data unit, inter-layer residual prediction, and inter-layer intra prediction have been described above with respect to exemplary embodiments. The above-described exemplary embodiments of inter-layer prediction are applicable to the scalable video encoding apparatus 100 and the scalable video decoding apparatus 200, although the inter-layer prediction according to exemplary embodiments is not limited thereto.

According to an exemplary embodiment, an image of a higher layer may be predicted and encoded according to the inter-layer intra prediction among inter-layer predictions.

<Mapping Relationship Between Higher/Lower Layer Data Units in Inter-Layer Prediction>

The higher layer data unit and the lower layer data unit differ in terms of spatial resolution, temporal resolution, or image quality according to a scalable video encoding method, and thus the scalable video encoding apparatus 100 according to an exemplary embodiment and the scalable video decoding apparatus 200 according to an exemplary embodiment may determine and refer to the lower layer data unit corresponding to the higher layer data unit for inter-layer prediction.

For example, according to scalable video encoding and decoding methods based on spatial scalability, a lower layer image and a higher layer image differ in terms of spatial resolution. In general, the resolution of the lower layer image is smaller than a resolution of the higher layer image. Thus, to determine a location of the lower layer data unit corresponding to the higher layer data unit, a resizing ratio of resolution may be considered. A resizing ratio between the higher and lower layer data units may be optionally determined. For example, a mapping location may be exactly determined as a sub-pixel level such as 1/16 pixel size.

When locations of the higher and lower data units are presented as coordinates, mapping equations 1, 2, 3, and 4 for determining a coordinate of the lower layer data unit mapped to a coordinate of the higher layer data unit are as below. In the mapping equations 1, 2, 3, and 4, a function Round( ) outputs a rounded value of an input value.

$$\begin{matrix}{B}_{x} = Round ( \frac{{E}_{x} * {D}_{x} + {R}_{x}}{{2}^{( S - 4 )}} ) & Mapping Equation 1 \\ {B}_{y} = Round ( \frac{{E}_{y} * {D}_{y} + {R}_{y}}{{2}^{( S - 4 )}} ) & Mapping Equation 2 \\ {D}_{x} = Round ( \frac{{2}^{S} * BaseWidth}{ScaledBaseWidth} ) & Mapping Equation 3 \\ {D}_{y} = Round ( \frac{{2}^{S} * BaseHeight}{ScaledBaseHeight} ) & Mapping Equation 4\end{matrix}$$

In the mapping equations 1 and 2, Bx and By denote x and y axis coordinate values of the lower layer data unit, respectively, and Ex and Ey denote x and y axis coordinate values of the higher layer data unit, respectively. Rx and Ry denote reference offsets in x and y axis directions to improve accuracy of each mapping. In the mapping equations 3 and 4, BaseWidth and BaseHeight denote a width and height of the lower layer data unit, respectively, and ScaledBaseWidth and ScaledBaseHeight denote a width and height of the upsampled lower layer data unit, respectively.

Thus, the x and y axis coordinate values of the lower layer data unit corresponding to the x and y axis coordinate values of the higher layer data unit may be determined by using the reference offsets for accurate mapping and the resizing ratio of resolution.

However, the above-described mapping equations 1, 2, 3, and 4 are only exemplary embodiments for understanding certain exemplary embodiments, and the exemplary embodiments are not limited thereto.

Mapping locations between the lower and higher layer data units may be determined in consideration of diverse factors according to the exemplary embodiments. For example, the mapping locations between the lower and higher layer data units may be determined in consideration of one or more factors such as a resolution ratio between lower and higher layer videos, an aspect ratio, a translation distance, an offset, etc.

The scalable video encoding apparatus 100 according to an exemplary embodiment and the scalable video decoding apparatus 200 according to an exemplary embodiment may perform inter-layer prediction based on coding units having a tree structure. According to coding units having the tree structure, the coding units are determined according to depths, and thus sizes of coding units are not the same. Thus, locations of lower layer coding units corresponding to higher layer coding units are separately determined.

Available diverse mapping relationships between data units of diverse levels of a higher layer image including maximum coding units, coding units, prediction units, transformation units, or partitions and data units of diverse levels of a lower layer image will now be described.

FIG. 7 is a diagram for explaining a mapping relationship between a lower layer and a higher layer, according to an exemplary embodiment.

In particular, FIG. 7 is a diagram for explaining a mapping relationship between a lower layer and a higher layer for inter-layer prediction based on coding units having a tree structure. A lower layer data unit determined to correspond to a higher layer data unit may be referred to as a reference layer data unit.

For inter-layer prediction according to an exemplary embodiment, a location of a lower layer maximum coding unit 710 corresponding to a higher layer maximum coding unit 720 may be determined. For example, the lower layer maximum coding unit 710 including a left top sample 780 may be determined to be a data unit corresponding to the higher layer maximum coding unit 720 by searching for a data unit among lower layer data units to which the left top sample 780 corresponding to a left top sample 790 of the higher layer maximum coding unit 720 belongs.

In a case where a structure of a higher layer coding unit may be inferred from a structure of a lower layer coding unit through inter-layer prediction according to an exemplary embodiment, a tree structure of coding units included in the higher layer maximum coding unit 720 may be determined in the same manner as a tree structure of coding units included in the lower layer maximum coding unit 710.

Similarly to coding units, sizes of partitions (prediction units) or transformation units included in coding units having the tree structure may be variable according to a size of a corresponding coding unit. Even sizes of partitions or transformation units included in coding units having the same size may be varied according to partition types or transformation depths. Thus, in partitions or transformation units based on coding units having the tree structure, locations of lower layer partitions or lower layer transformation units corresponding to higher layer partitions or higher layer transformation units are separately determined.

In FIG. 7, a location of a predetermined data unit, for example, the left top sample 780, of the lower layer maximum coding unit 710 corresponding to the left top sample 790 of the higher layer maximum coding unit 720 is searched for to determine a reference layer maximum coding unit for inter-layer prediction. Similarly, a reference layer data unit may be determined by comparing a location of a lower layer data unit corresponding to a left top sample of a higher layer data unit, by comparing locations of centers of the lower layer and higher layer data units, or by comparing predetermined locations of the lower layer and higher layer data units.

Although a case where maximum coding units of another layer for inter-layer prediction are mapped is exemplified in FIG. 7, data units of another layer may be mapped with respect to various types of data units including maximum coding units, coding units, prediction units, partitions, transformation units, and minimum units.

Therefore, the lower layer data unit may be upsampled by a resizing ratio or an aspect ratio of spatial resolution to determine a lower layer data unit corresponding to a higher layer data unit for inter-layer prediction according to an exemplary embodiment. An upsampled location may be moved by a reference offset so that a location of the reference layer data unit may be accurately determined. Information regarding the reference offset may be explicitly transmitted and received between the scalable video encoding apparatus 100 and the scalable video decoding apparatus 200. However, although the information regarding the reference offset is not transmitted and received, the reference offset may be predicted based on peripheral motion information, disparity information of the higher layer data unit, or a geometric shape of the higher layer data unit.

Encoding information regarding a location of the lower layer data unit corresponding to a location of the higher layer data unit may be used to predict inter-layer prediction of the higher layer data unit. Encoding information that may be referred to may include at least one of coding modes, predicted values, reconstructed values, information on structure of data units, and syntax.

For example, a structure of the higher layer data unit may be inferred from a corresponding structure (a structure of maximum coding units, a structure of coding units, a structure of prediction units, a structure of partitions, a structure of transformation units, etc.) of the lower layer data unit.

Inter-layer prediction between a group of two or more data units of the lower layer image and the corresponding group of data units of the higher layer image may be performed and a comparison between single data units of the lower layer and higher layer images may also be performed. A group of lower layer data units including a location corresponding to a group of higher layer data units may be determined.

For example, among lower layer data units, a lower layer data unit group including a data unit corresponding to a data unit of a predetermined location among higher layer data unit groups may be determined as a reference layer data unit group.

Data unit group information may represent a structure condition for constituting groups of data units. For example, coding unit group information for higher layer coding units may be inferred from coding unit group information for constituting a group of coding units in a lower layer image. For example, the coding unit group information may include a condition that coding units having depths lower than or identical to a predetermined depth constitute a coding unit group, a condition that coding units less than a predetermined number constitute a coding unit group, etc.

The data unit group information may be explicitly encoded and transmitted and received between the scalable video encoding apparatus 100 and the scalable video decoding apparatus 200. As another example, although the data unit group information is not transmitted and received, group information of the higher layer data unit between the scalable video encoding apparatus 100 and the scalable video decoding apparatus 200 may be predicted from group information of the lower layer data unit.

Similarly to the coding unit group information, group information of a higher layer maximum coding unit (transformation unit) may be inferred from group information of a lower layer maximum coding unit (transformation unit) through inter-layer prediction.

Inter-layer prediction is possible between higher and lower layer slices. Encoding information of the higher layer slice including the higher layer data unit may be inferred by referring to encoding information of the lower layer slice including the lower layer data unit including a location corresponding to the higher layer data unit. Encoding information regarding slices may include all encoding information of data units included in slices as well as information regarding slice structures such as slice shapes.

Inter-layer prediction is possible between higher and lower layer tiles. Encoding information of the higher layer tile including the higher layer data unit may be inferred by referring to encoding information of the lower layer tile including the lower layer data unit including the location corresponding to the higher layer data unit. Encoding information regarding tiles may include all encoding information of data units included in tiles as well as information regarding tile structures such as tile shapes.

The higher layer data unit may refer to lower layer data units having the same type as described above. The higher layer data unit may also refer to lower layer data units having different types as described above.

Diverse encoding information of the lower layer data unit that may be used by the higher layer data unit is described in <Encoding Information that may be referred to in Inter-layer Prediction> above. However, the encoding information that may be referred to in inter-layer prediction according to the technical concept of the exemplary embodiments is not limited to the above-described encoding information, and may be implemented as various types of data that may occur as a result of encoding the higher layer image and the lower layer image.

A single piece of encoding information may not be referred to between the higher and lower layer data units for inter-layer prediction and a combination of at least one piece of encoding information may be referred to. At least one piece of encoding information that may be referred to may be combined in various ways and thus, a reference encoding information set may be set in various ways.

Likewise, diverse mapping relationships between the higher layer data unit and the lower layer data unit are described in <Mapping Relationships between Higher and Lower Layer Data Units in Inter-layer Prediction> above. However, the mapping relationship between the higher layer data unit and the lower layer data unit in inter-layer prediction according to the technical concept of the exemplary embodiments is not limited to the above-described mapping relationships, but may be implemented as various types of mapping relationships between a higher layer data unit (group) and a lower layer data unit (group) that may be related to each other.

Moreover, a combination of the reference encoding information set that may be referred to between the higher and lower layer data units for inter-layer prediction and the mapping relationship therebetween may also be set in various ways. For example, the reference encoding information set for inter-layer prediction may be set in various ways such as α, β, γ, δ, . . . , and the mapping relationship between the higher and lower layer data units may be set in various ways such as I, II, III, V . . . . In this case, the combination of the reference encoding information set and the mapping relationship may be set as at least one of “encoding information set α and mapping relationship I”, “α and II”, “α and III”, “α and V”, . . . , “encoding information set β and mapping relationship I”, “β and II”, “β and III”, “β and V”, . . . , “encoding information set γ and mapping relationship I”, “γ and II”, “γ and III”, “γ and V”, . . . , “encoding information set δ and mapping relationship I”, “δ and II”, “δ and III”, “δ and V”, . . . . Two or more reference encoding information sets may be set to be combined with a single mapping relationship or two or more mapping relationships may be set to be combined with a single reference encoding information set.

Exemplary embodiments of mapping data units of different levels in inter-layer prediction between higher and lower layer images will now be described.

For example, higher layer coding units may refer to encoding information regarding a group of lower layer maximum coding units including corresponding locations. To the contrary, higher layer maximum coding units may refer to encoding information regarding the group of lower layer coding units including corresponding locations.

For example, encoding information of higher layer coding units may be determined by referring to the encoding information regarding the lower layer maximum coding unit group including corresponding locations. That is, lower layer maximum coding units that may be referred to may include all respective locations corresponding to all locations of higher layer coding units.

Similarly, encoding information of higher layer maximum coding units may be determined by referring to encoding information regarding the lower layer coding unit group including corresponding locations. That is, lower layer coding units that may be referred to may include all respective locations corresponding to all locations of higher layer maximum coding units.

According to an exemplary embodiment, it may be determined whether to perform inferred inter-layer prediction separately for each sequence, each picture, each slice or each maximum coding unit as described above.

Although inter-layer prediction is performed on a predetermined data unit, inferred inter-layer prediction may be partially controlled within the predetermined data unit. For example, in a case where it is determined whether to perform inter-layer prediction of a maximum coding unit level, although inter-layer prediction is performed on a current maximum coding unit of the higher layer image, inferred inter-layer prediction is performed only on data units of a partial level among data units of low levels included in the current maximum coding unit by using corresponding lower layer data units, and inferred inter-layer prediction is not performed on other data units having no corresponding lower layer data units. The data units of low levels in the current maximum coding unit may include coding units, prediction units, transformation units, and partitions in the current maximum coding unit, and the data units of a partial level may be at least one of coding units, prediction units, transformation units, and partitions. Thus, data units of the partial level included in higher layer maximum coding units may be inferred from lower layer data units, whereas encoding information regarding data units of the other levels in the higher layer maximum coding units may be encoded and transmitted and received.

For example, in a case where inter-layer prediction is performed only on higher layer maximum coding units, higher layer coding units having corresponding lower layer coding units among coding units of higher layer maximum coding units may be predicted by referring to a reconstructed image generated by performing intra prediction of lower layer coding units. However, single layer prediction using the higher layer image, other than inter-layer prediction, may be performed on higher layer coding units having no corresponding intra predicted lower layer coding units.

Inferred inter-layer prediction for higher layer data units may also be also only when a predetermined condition regarding lower layer data units is satisfied. The scalable video encoding apparatus 100 may transmit information indicating whether inferred inter-layer prediction is performed in a case where the predetermined condition is satisfied and inferred inter-layer prediction is possible. The scalable video decoding apparatus 200 may parse information indicating whether inferred inter-layer prediction is possible, read the parsed information, determine which predetermined condition is satisfied and inferred inter-layer prediction has been performed, and determine coding modes of higher layer data units by referring to a combination of a series of coding modes of lower layer data units when the predetermined condition is satisfied.

For example, residual prediction between prediction units of different layers may be performed only when sizes of higher layer prediction units are greater than or equal to sizes of lower layer prediction units. For example, inter-layer prediction between maximum coding units of different layers may be performed only when sizes of higher layer maximum prediction units are greater than or equal to sizes of lower layer maximum prediction units. This is because lower layer maximum coding units or lower layer prediction units are up-sampled according to a resolution resizing ratio or aspect ratio.

As another example, an inferred inter-layer prediction mode may be possible under a condition of a predetermined slice type such as slices I-, B-, and P- of higher layer data units.

Prediction according to an inter-layer intra skip mode is an example of inferred inter-layer prediction. According to the inter-layer intra skip mode, residual information of an intra mode for higher layer data units does not exist, and thus a lower layer intra reconstructed image corresponding to higher layer data units may be used as an intra reconstructed image of higher layer data units.

Thus, as a specific example, it may be determined whether to encode (decode) information indicating the inter-layer intra skip mode according to whether slice types of higher layer data units are slice types of the inter mode such as slices B- and P- or slice types of the intra mode such as a slice I-.

Encoding information of lower layer data units may be used in a corrected format or a downgraded format for inter-layer prediction.

For example, motion vectors of lower layer partitions may be reduced to an accuracy of a specific pixel level like an integer pixel level and a sub-pixel level of a ½ pixel level, and may be used as motion vectors of higher layer partitions.

As another example, motion vectors of a plurality of lower layer partitions may be merged into one motion vector and referred to by higher layer partitions.

For example, a region in which motion vectors are combined may be determined as a fixed region. Motion vectors may be combined only in partitions included in a region having a fixed size or data units of fixed neighboring locations.

As another example, although two or more lower layer data units correspond to higher layer data units of predetermined sizes, motion vectors of higher layer data units may be determined by using only motion information of a single data unit among lower layer data units. For example, a motion vector of a lower layer data unit of a predetermined location among a plurality of lower layer data units corresponding to 16×16 higher layer data units may be used as a motion vector of a higher layer data unit.

In another case, control information for determining the region in which motion vectors are combined may be inserted into a sequence parameter set (SPS), a picture parameter set (PPS), an adaptation parameter set (APS), or a slice header and transmitted. Thus, the control information for determining the region in which motion vectors are combined may be parsed for each sequence, each picture, each adaptation parameter, or each slice. For example, motion information of lower layer partitions may be modified and stored. Originally, the motion information of lower layer partitions is stored as a combination of a reference index and motion vector. However, the motion information of lower layer partitions according to an exemplary embodiment may be stored after a size thereof is adjusted or modified to a motion vector corresponding to a reference index that is assumed to be 0. Accordingly, storage of the motion information of lower layer partitions may be reduced. For inter-layer prediction of higher layer partitions, the stored motion information of lower layer partitions may be modified again according to a reference image corresponding to a reference index of higher layer partitions. That is, motion vectors of higher layer partitions may be determined by referring to the modified motion information of lower layer partitions according to the reference image of higher layer partitions.

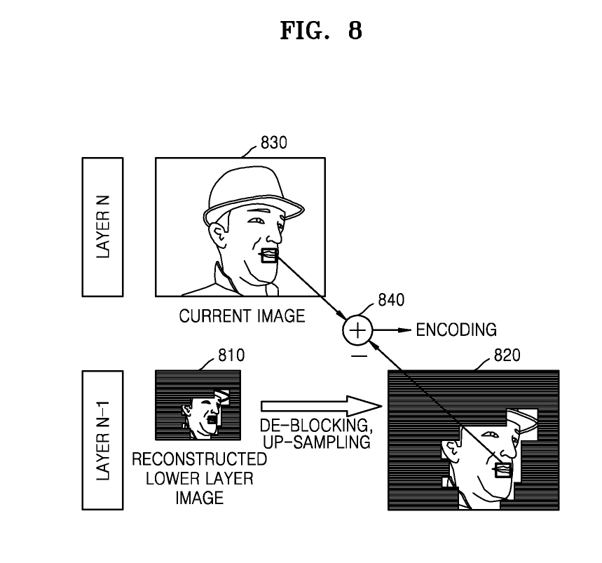

FIG. 8 is a diagram for explaining an example of inter-layer intra prediction, according to an exemplary embodiment.

According to an inter-layer intra prediction method, when a data unit of a lower layer image corresponding to a data unit of a higher layer image that is to be encoded is predicted and encoded in an inter mode, the scalable video encoding apparatus 100 according to an exemplary embodiment may up-sample a data unit of a reconstructed lower layer image and encode the higher layer image by using the up-sampled lower layer image.

The scalable video decoding apparatus 200 according to an exemplary embodiment may up-sample the data unit of the reconstructed lower layer image corresponding to a data unit of a higher layer image that is to be reconstructed and decode the higher layer image by using the up-sampled lower layer image.

According to an exemplary embodiment, the inter-layer intra prediction method may include an inter-layer intra prediction mode and an inter-layer intra skip mode.

The inter-layer intra prediction mode that may be referred to will be described in more detail with reference to FIG. 8 below.

Referring to FIG. 8, the scalable video encoding apparatus 100 may use data unit regions of a lower layer N−1 that are encoded in an intra prediction mode to predict and encode a higher layer N according to the inter-layer intra prediction method.

The scalable video encoding apparatus 100 may reconstruct a data unit of the lower layer image corresponding to a data unit of an image of a higher layer N that is to be predicted and encoded according to the inter-layer intra prediction method. The lower layer image may be not partially but completely reconstructed. In this regard, the scalable video encoding apparatus 100 may apply a de-blocking filter to a reconstructed lower layer image 810 so as to remove a blocking effect between blocks that occurs between adjacent data units.

The scalable video encoding apparatus 100 may up-sample the lower layer image 810 to which the de-blocking filter is applied and encode a residual signal 840 obtained by differentiating an up-sampled lower layer image 820 and a higher layer image 830, thereby encoding the higher layer image for data units.

Alternatively, the scalable video encoding apparatus 100 may encode the residual signal 840, which is a value obtained by differentiating a prediction image obtained by performing inter prediction between the up-sampled lower layer image 820 and the higher layer image 830, thereby encoding the higher layer image for data units.

The scalable video encoding apparatus 100 may encode the residual signal 840, which is a value obtained by differentiating a prediction image obtained by performing intra prediction on a data unit of the higher layer image 830 based on the up-sampled lower layer image 820 and the higher layer image 830, thereby encoding the higher layer image for data units.

When the higher layer image is encoded according to the inter-layer intra skip mode, the scalable video encoding apparatus 100 may generate and signal only a flag indicating the higher layer image is encoded according to the inter-layer intra skip mode while not obtaining the residual signal 840 as in the inter-layer intra mode. That is, the residual signal 840 may not be encoded according to the inter-layer intra skip mode.

When the higher layer image is decoded according to the inter-layer intra prediction method, the scalable video decoding apparatus 200 according to an exemplary embodiment may parse and obtain an encoded residual signal from a bitstream. The scalable video decoding apparatus 200 may reconstruct a data unit of a lower layer image corresponding to a data unit of a higher layer image that is to be decoded.

The scalable video decoding apparatus 200 may apply a de-blocking filter to the reconstructed lower layer image and up-sample the lower layer image to which the de-blocking filter is applied. The scalable video decoding apparatus 200 may obtain the higher layer image by using the up-sampled lower layer image and the obtained residual signal.

For example, the scalable video decoding apparatus 200 may obtain the higher layer image by summing the residual signal and the up-sampled lower layer image.

For example, the scalable video decoding apparatus 200 may sum a prediction image obtained by performing inter prediction or intra prediction and the residual signal, thereby obtaining the higher layer image.

When the higher layer image is decoded in the inter-layer intra skip mode according to a flag indicating the inter-layer intra skip mode, the scalable video decoding apparatus 200 may reconstruct the data unit of the lower layer image corresponding to the data unit of the higher layer image that is to be decoded.

The scalable video decoding apparatus 200 may apply the de-blocking filter to the reconstructed lower layer image and up-sample the lower layer image to which the de-blocking filter is applied. The scalable video decoding apparatus 200 may obtain the higher layer image by using the up-sampled lower layer image. For example, the scalable video decoding apparatus 200 may use pixel values of the up-sampled lower layer image as pixel values of the higher layer image.

According to an exemplary embodiment, the scalable video decoding apparatus 200 may decode an image based on a flag that indicates a prediction encoding method and is transmitted for each of data units of the image. In this regard, the prediction encoding method may include at least one of the inter-layer intra prediction method, an inter prediction mode, an intra prediction mode, and a skip mode. A data unit may include maximum coding units, coding units, and prediction units.

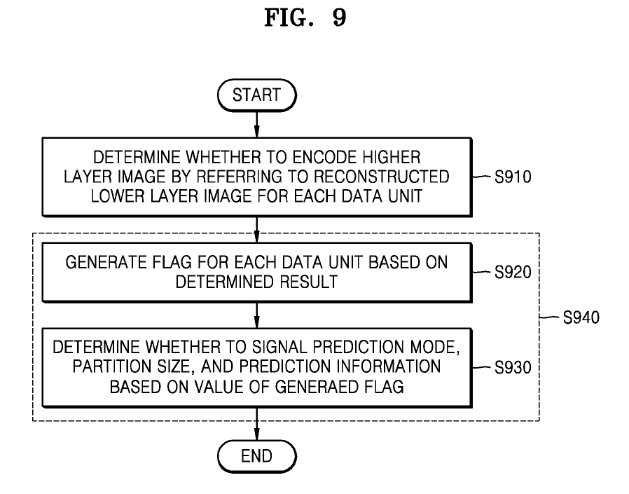

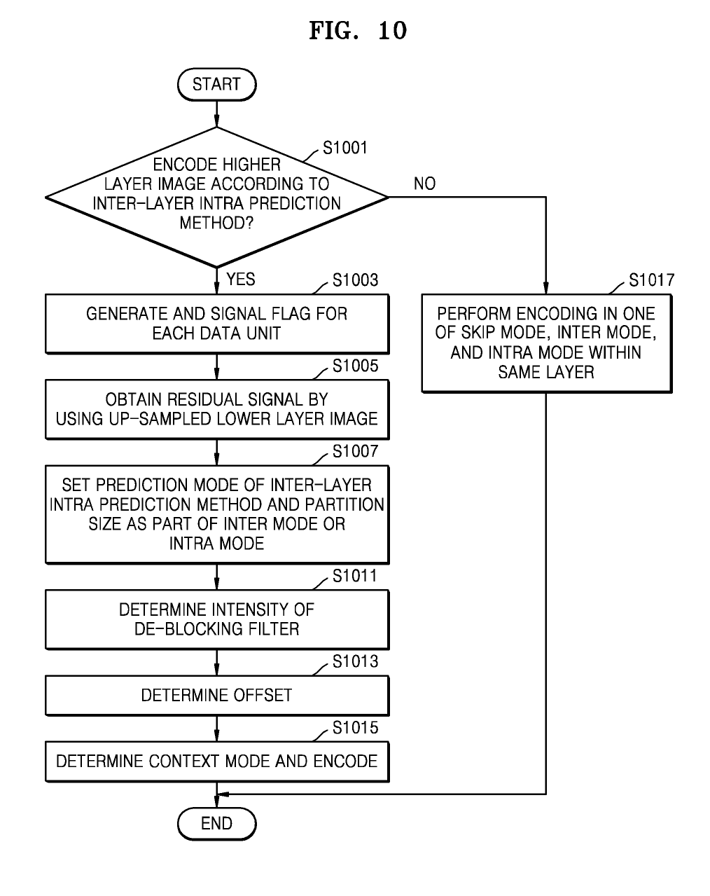

FIGS. 9 and 10 are flowcharts of a scalable video encoding method according to exemplary embodiments.

Referring to FIG. 9, in operation S910, the scalable video encoding apparatus 100 may determine whether to encode a higher layer image by referring to a reconstructed lower layer image for each data unit. For example, the scalable video encoding apparatus 100 may determine whether to encode the higher layer image in an inter-layer intra prediction mode or an inter-layer intra skip mode that may encode the higher layer image by referring to the lower layer image.

In operation S940, the scalable video encoding apparatus 100 may encode the higher layer image based on a result determined in operation S910. Thus, the scalable video encoding apparatus 100 may perform operations S920 and S930 in operation S940 so as to encode the higher layer image.

In operation S920, the scalable video encoding apparatus 100 may generate a flag for each data unit based on the result determined in operation S910.

For example, the scalable video encoding apparatus 100 may generate a flag indicating the inter-layer intra prediction mode or a flag indicating the inter-layer intra prediction skip mode. For example, when a flag value is 1, prediction and encoding may be performed according to a corresponding prediction mode, and when the flag value is 0, prediction and encoding may not be performed according to the corresponding prediction mode.

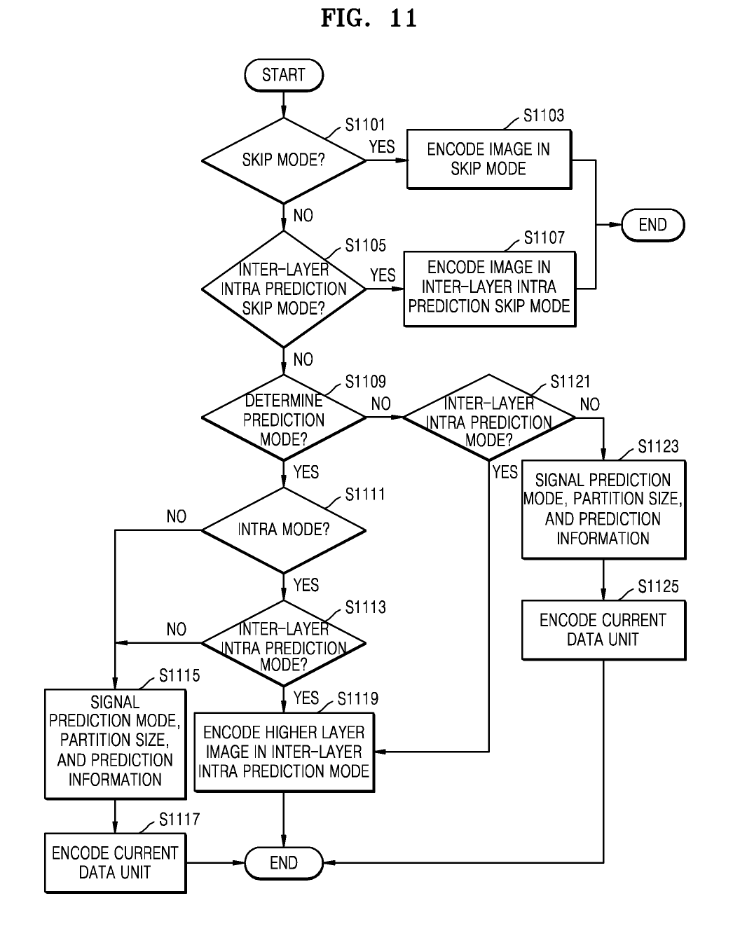

That is, a flag indicating whether to perform encoding by using a corresponding prediction method may be generated for each prediction method. Flags may be generated for all prediction methods or for some prediction methods. Flags may be generated and signaled for a part of prediction methods according to an order of signaling each flag. An exemplary embodiment in which a flag indicating a prediction method is signaled will be described with reference to FIG. 11 below.

A data unit for generating the flag value may include at least one of maximum coding units, coding units, and prediction units. That is, for each of maximum coding units, coding units, and prediction units, the flag value indicating whether to perform encoding by using a corresponding prediction method may be generated for each prediction method in operation S920.

In operation S930, the scalable video encoding apparatus 100 may determine whether to signal information when prediction is performed between images of the same layer as a higher layer, e.g., when prediction is performed in an inter mode, or when prediction and encoding are performed in the higher layer image, e.g., when prediction and encoding are performed in an intra mode, for each data unit based on the flag value generated in operation S920. When the prediction mode is the inter mode, prediction information may include a partition type of a prediction unit by inter prediction, a reference index, and a motion vector. When the prediction mode is the intra mode, the prediction information may include the partition type of the prediction unit by intra prediction, information regarding a chroma component of the intra mode, and information regarding an interpolation method of the intra mode.

That is, the scalable video encoding apparatus 100 may signal a partition size, the prediction mode, and the prediction information that are information when an image is encoded according to the prediction mode other than the inter-layer intra prediction method according to whether to encode the image according to the inter-layer intra prediction method of encoding the image by referring to the lower layer image.

According to an exemplary embodiment, the prediction mode other than the inter-layer intra prediction method may not include prediction modes included in the inter-layer prediction mode, e.g., an inter-layer motion prediction mode or an inter-layer residual prediction mode.

When the higher layer image is encoded according to the inter-layer intra prediction method, the system may not necessarily signal a prediction mode, a partition size, and prediction information that are used when the higher layer image is encoded in the inter mode or the intra mode in which prediction is performed in the higher layer image or between same layer images. Thus, if a flag indicating that the higher layer image is encoded according to the inter-layer intra prediction method is 1, the prediction information may not be signaled, and, if the flag is 0, the prediction mode, the partition size, and the prediction information may be determined during a prediction and encoding process and then signaled.

The scalable video encoding method based on a prediction method according to an exemplary embodiment will now be described in more detail with reference to FIG. 10 below.

Referring to FIG. 10, in operation S1001, the scalable video encoding apparatus 100 may determine whether to encode a higher layer image by referring to a reconstructed lower layer image for each data unit. In particular, the scalable video encoding apparatus 100 may determine if the higher layer image is encoded according to an inter-layer intra prediction method or according to one of an inter mode, an intra mode, and a skip mode. The prediction method may be determined based on encoding efficiency as described above. The prediction method may be determined for each data unit.

Although the prediction method includes an inter-layer motion prediction mode or an inter-layer residual prediction mode that is included in an inter-layer prediction mode, according to an exemplary embodiment, prediction modes included in the inter-layer prediction mode may determine and signal a flag value and encoding information for encoding as in the inter-layer intra prediction method. For example, the scalable video encoding apparatus 100 may set and signal a flag indicating whether to encode the higher layer image according to the inter-layer prediction mode or one of the inter mode, the intra mode, and the skip mode. The scalable video encoding apparatus 100 may generate and signal encoding information according to the inter-layer prediction method, for example, motion information of the lower layer image or residual information.

In operation S1003, when the higher layer image is encoded according to the inter-layer intra prediction method, the scalable video encoding apparatus 100 may generate and signal a flag indicating that the higher layer image is encoded according to the inter-layer intra prediction method for each data unit. When the higher layer image is encoded according to the inter-layer intra prediction method, a flag value may be set as 1, and, when the higher layer image is encoded according to other prediction methods, the flag value may be set as 0.

In operation 1005, the scalable video encoding apparatus 100 may obtain a lower layer image corresponding to the higher layer image that is to be encoded or a partial region of the higher layer image and a partial region of the lower layer image. For convenience of description, an exemplary embodiment in which an image is reconstructed and encoded will be described below. However, the exemplary embodiments do not exclude exemplary embodiments in which a partial region of the image or the image for data units is reconstructed and encoded.

The scalable video encoding apparatus 100 may reconstruct the obtained lower layer image and up-sample the reconstructed lower layer image in accordance with the resolution of the higher layer image. The scalable video encoding apparatus 100 may obtain a residual signal by calculating a differential value of the up-sampled lower layer image and the higher layer image.

Alternatively, the scalable video encoding apparatus 100 may obtain a residual signal by generating a prediction image by using the up-sampled lower layer image and the higher layer image according to an inter mode or an intra mode that may be set in operation S1007, and calculating a differential value of the generated prediction image and the higher layer image. That is, the scalable video encoding apparatus 100 may generate and signal prediction information for predicting the higher layer image according to the inter-layer intra prediction method that is set as a part of the inter mode and the intra mode.

The residual signal may be residually coded and encoded according to the inter-layer intra prediction method.

The scalable video encoding apparatus 100 may perform entropy encoding on the residual signal obtained in operation S1005 that will be described later. In this regard, the residual signal may be encoded according to a residual quadtree (RQT) or a coded block flag (CBF) that may be used in the inter mode or the intra mode for each coding unit. In particular, when the residual signal is coded according to the RQT, information regarding the RQT including maximum depth information of the RQT may be signaled as a part of information that may be included in a slice header, an SPS, and a PSS in the inter mode or the intra mode. A maximum depth of the RQT may have a constant value, for example, 1 or 2.

Taking into consideration that a coefficient of the residual signal is mostly 0 in that the residual signal between two images having the same view and different layers is coded, the scalable video encoding apparatus 100 may further include a flag indicating whether the coefficient of the residual signal of each coding unit is 0 or not. For example, if a flag value is 1, the coefficient of the residual signal has a value other than 0, and, if the flag value is 0, the coefficient of the residual signal has a value of 0.

When the higher layer image is encoded according to an inter-layer intra prediction skip mode of the inter-layer intra prediction method, the scalable video encoding apparatus 100 does not encode the residual signal, and thus operations S1007 through S1015, except for operation S1005, may be performed.

According to circumstances, operations S1011 through S1015, except for operations S1005 and S1007, may be performed. That is, when the scalable video encoding apparatus 100 does not perform prediction according to the prediction mode set in operation S1007 and decodes or reconstructs the higher layer image, a pixel value of the up-sampled lower layer image may be determined as a pixel value of the higher layer image.

In operation S1007, the scalable video encoding apparatus 100 may set prediction information of the inter-layer intra prediction method as a part of the inter mode or the intra mode. In other words, the scalable video encoding apparatus 100 may generate and signal prediction information for predicting the higher layer image according to the inter-layer intra prediction method that is set as a part of the inter mode or the intra mode.

For example, when the inter-layer intra prediction method is set as the inter mode used as motion prediction, prediction information of the inter-layer intra prediction method may be set as motion information thereof. For example, the prediction information may be set as one of motion information of a scaled base layer, zero motion information, and first motion candidate information when various motion candidates are included. The prediction information of the inter-layer intra prediction method is information that may be used when an image is predicted and encoded or decoded according to the inter-layer intra prediction method.

That is, the motion information is information for predicting motion of an object that may be used in inter-screen prediction, and thus, according to the inter-layer intra prediction method, motion of an object between the lower layer image and the higher layer image may be set as motion information. However, since the lower layer image and the higher layer image are images of the same view, no motion of the object may be present, and thus the prediction information may be set as the zero motion information.

Therefore, according to an exemplary embodiment, the scalable video encoding apparatus 100 may signal the prediction information of the inter-layer intra prediction method by setting the prediction information of the inter-layer intra prediction method as one of motion information of the inter mode.

When the inter-layer intra prediction method is set as the intra mode that may be used as intra-screen prediction, the prediction information of the inter-layer intra prediction method may be set as a part of intra mode prediction information. For example, a luma intra mode or a chroma intra mode of the inter-layer intra prediction method may be set as one of a DC mode, a planer mode, an angular mode, and Intra_FromLuma.

That is, when the inter-layer intra prediction method is set as the intra mode, the higher layer image may be encoded by performing intra prediction in one of 35 intra prediction modes at the maximum with respect to the up-sampled lower layer image.

The prediction information of the inter-layer intra prediction method may be set as newly added motion information or a newly added prediction mode. For example, according to an exemplary embodiment, since the existing intra mode has 35 prediction mode numbers, a prediction mode number 36 may be newly added. Thus, the prediction information of the inter-layer intra prediction method may be set as newly added motion information of a prediction mode having the prediction mode number 36 of the intra mode or an inter mode.

The scalable video encoding apparatus 100 may signal partition size information in a prediction unit as a partition size allowed in the inter mode or the intra mode when encoding the higher layer image according to the inter-layer intra prediction method.

For example, in a case where the prediction information is generated according to the inter mode, the scalable video encoding apparatus 100 may signal the partition size information in the prediction unit as the partition size allowed in the inter mode when encoding the higher layer image according to the inter-layer intra prediction method.

In a case where the prediction information is generated according to the intra mode, the scalable video encoding apparatus 100 may signal the partition size information in the prediction unit as the partition size allowed in the intra mode when encoding the higher layer image according to the inter-layer intra prediction method.

The scalable video encoding apparatus 100 may explicitly signal the partition size, except when the partition size is 2N×2N. Thus, when the partition size is not signaled, the partition size may be estimated as 2N×2N.

In operation S1011, the scalable video encoding apparatus 100 may determine the intensity of a de-blocking filter that is to be applied for each coding unit.

The determined intensity of the de-blocking filter may have a value of 2 in the intra mode or a value of 0 or 1 in the inter mode. That is, prediction may be performed in the inter mode or the intra mode according to the inter-layer intra prediction method, and thus the intensity of the de-blocking filter may be determined according to a performed prediction mode.

For example, in a case where the prediction information is generated according to the inter mode, the scalable video encoding apparatus 100 may determine the intensity of the de-blocking filter in the inter mode when encoding the higher layer image according to the inter-layer intra prediction method.

In a case where the prediction information is generated according to the intra mode, the scalable video encoding apparatus 100 may determine the intensity of the de-blocking filter in the intra mode when encoding the higher layer image according to the inter-layer intra prediction method.

The intensity of the de-blocking filter may be determined according to whether a block boundary is predicted according to the inter-layer intra prediction method. For example, when left and right prediction units positioned in boundaries of blocks split into 8×8 block units are predicted according to the inter-layer intra prediction method or include a residual signal other than 0, since a block distortion occurs in the middle, the intensity of the de-blocking filter may be set as 1.

In operation S1013, the scalable video encoding apparatus 100 may determine an offset for shifting a region of the lower layer image that is to be referred to for encoding the higher layer image.

When there is a need to move the region of the lower layer image that is to be referred to, corresponding to the higher layer image, in a distortion between the higher layer image and the lower layer image, the scalable video encoding apparatus 100 may determine and encode an offset value.

When the offset value is signaled in the form of a motion vector, the offset may be signaled in the form of a motion vector of one of a quarter pel accuracy, a half pel accuracy, and an integer pel accuracy. For example, when the offset is signaled in the half pel accuracy, the offset value may be signaled in the motion vector of the half pel accuracy, and a region of a position shifted by the motion vector in the up-sampled lower layer image, e.g., in the region corresponding to the higher layer image that is to be encoded, may be referred to for encoding the higher layer image.

When the offset value is signaled in an index, each index value may indicate a region that may be referred to for encoding the higher layer image of each of regions of positions shifted by (0,0), (−1,0), (0,1), (0,−1), (−1,−1), (1,1,), and (1,−1) in the up-sampled lower layer image, e.g., in the region corresponding to the higher layer image that is to be encoded.

The offset value may be determined and signaled for each data unit that is signaled according to the inter-layer intra prediction method or may be signaled in slice, tile, picture, and sequence units. When the offset value is signaled in the slice, tile, picture, and sequence units, the signaled offset value may be in the same way applied to each of a maximum coding unit, a coding unit, and a prediction unit that are included in the slice, tile, picture, and sequence.

Although the offset value may be explicitly signaled in the form of the motion vector or the index as described above, the offset value may be implicitly determined. That is, when an encoding end or a decoding end needs to shift the region due to the distortion between the lower layer image and the higher layer image, the encoding end or the decoding end may perform encoding or decoding by directly setting the offset value, shifting the region of the lower layer image according to the offset value, and using the shifted region of the lower layer image.

In operation S1015, the scalable video encoding apparatus 100 may determine a context model of context-based adaptive binary arithmetic coding (CABAC) according to the inter-layer intra prediction method and encode the higher layer image according to the determined context model.

The context model is a probability model with respect to bin, and includes information regarding which value of 0 and 1 correspond to a most probable symbol (MPS) and a least probable symbol (LPS), and a probability of the MPS or the LPS. The context model is the probability model used to perform binary arithmetic encoding of a syntax element related to a current encoding block based on the number of times the current encoding block spatially split from a maximum coding unit.

According to an exemplary embodiment, the context model may be determined based on information regarding left and upper data units that are spatially neighboring a current data unit. That is, the context model may be determined with respect to the current data unit based on information regarding neighboring data units in a z-scan order.

The context model may also be determined based on a coding depth of the current coding unit that is to be encoded. The coding depth of the current data unit may refer to the number of times the maximum coding unit of the current encoding block is spatially split. A size of the coding unit may vary according to a depth of the coding unit, and thus the context model may be determined in consideration of the coding depth of the current coding unit.

For example, the context model may be differently determined when the coding depth of the coding unit is 1 and 2.

The scalable video encoding apparatus 100 according to an exemplary embodiment may entropy encode the information set in operation S1007, the residual signal obtained in operation S1005, the intensity of the de-blocking filter determined in operation S1011, and the offset value determined in operation S1013 according to the context model determined in operation S1015.

When the higher layer image is not encoded according to the inter-layer intra prediction method in operation S1001, in operation S1017, the scalable video encoding apparatus 100 may prediction encode the higher layer image in one of the skip mode, the inter mode, and the intra mode within the same layer of the higher layer image that is to be encoded.

FIG. 11 is a flowchart of a method of signaling a flag or prediction information, according to an exemplary embodiment.

Referring to FIG. 11, in operation S1101, the scalable video encoding apparatus 100 may first signal a skip flag indicating whether a data unit of an image that is to be encoded is predicted in a skip mode, using a method of signaling a prediction mode or prediction information with respect to the data unit of the image.

When the image is predicted in the skip mode in operation S1101, in operation S1103, the scalable video encoding apparatus 100 may predict and encode the image in the skip mode. That is, the scalable video encoding apparatus 100 may signal the skip flag, and the scalable video decoding apparatus 200 that receives the signaled skip flag may not perform prediction in the skip mode and may decode the image of a partial region of the image by referring to a previous image. The previous image may be an image having a POC order preceding a POC order of the image. For example, the scalable video decoding apparatus 200 may determine each pixel value of the previous image as a pixel value of a position corresponding to each pixel value of the image so as to decode the image. Whether to predict and encode the image in the skip mode may be determined for each data unit.

In operation S1105, the scalable video encoding apparatus 100 may signal an inter-layer intra prediction skip flag indicating whether the image is predicted in an inter-layer intra prediction skip mode.

When the image is predicted in the inter-layer intra prediction skip mode in operation S1105, in operation S1107, the scalable video encoding apparatus 100 may predict and encode the image in the inter-layer intra prediction skip mode. That is, the scalable video encoding apparatus 100 may signal the inter-layer intra prediction skip flag, and the scalable video decoding apparatus 200 that receives the signaled inter-layer intra prediction skip flag may not obtain a residual signal between a lower layer image and a higher layer image in the inter-layer intra prediction skip mode and may decode the higher layer image or a partial region of the higher layer image by referring to the lower layer image.

Operation S1105 may be performed before operation S1101. That is, the scalable video encoding apparatus 100 may signal the inter-layer intra prediction skip flag before the skip flag.

In operation S1109, the scalable video encoding apparatus 100 may determine whether to signal a prediction mode including an inter mode and an intra mode before signaling the inter-layer intra prediction skip flag or whether to signal an inter-layer intra prediction flag indicating whether to encode the image in an inter-layer intra prediction mode before signaling the prediction mode.

When the prediction mode is first signaled, in operation S1111, the scalable video encoding apparatus 100 may determine whether to perform encoding in the intra mode or in the inter mode and signal the determined prediction mode.

When encoding is performed in the inter mode, in operation S1115, the scalable video encoding apparatus 100 may generate and signal at least one of a partition type of a prediction unit by inter prediction, a reference index, a reference list, and prediction information including a motion vector, a partition size, and a prediction mode.

In operation S1117, the scalable video encoding apparatus 100 may encode a current data unit according to the prediction information.

When encoding is performed in the intra mode, in operation S1113, the scalable video encoding apparatus 100 may determine and signal an inter-layer intra prediction flag. According to an exemplary embodiment, the inter-layer intra prediction flag is signaled in the intra mode, whereas the inter-layer intra prediction flag may be signaled in the inter mode according to setting.

When the scalable video encoding apparatus 100 does not encode and signal the image in the inter-layer intra prediction mode, since the scalable video encoding apparatus 100 may perform prediction and encoding in the intra mode, in operation S1115, the scalable video encoding apparatus 100 may generate and signal prediction information including information regarding an interpolation method of the intra mode, the partition size, and the prediction mode.

In operation S1117, the scalable video encoding apparatus 100 may encode the current data unit according to the prediction information.

When the scalable video encoding apparatus 100 encodes the image in the inter-layer intra prediction mode, in operation S1119, the scalable video encoding apparatus 100 may encode and signal the higher layer image for each data unit in the inter-layer intra prediction mode. That is, the scalable video encoding apparatus 100 may encode the higher layer image by referring to the lower layer image.

When the scalable video encoding apparatus 100 determines that the inter-layer intra prediction flag is signaled before the prediction mode in operation S1109, in operation S1121, the scalable video encoding apparatus 100 may determine and signal the inter-layer intra prediction flag.

When the scalable video encoding apparatus 100 encodes the image in the inter-layer intra prediction mode, in operation S1119, the scalable video encoding apparatus 100 may encode and signal the higher layer image for each data unit in the inter-layer intra prediction mode. That is, the scalable video encoding apparatus 100 may encode the higher layer image by referring to the lower layer image.

When the scalable video encoding apparatus 100 does not encode the image in the inter-layer intra prediction mode, in operation S1123, the scalable video encoding apparatus 100 may generate and signal at least one of a prediction mode, a partition size, and prediction information. When the image is encoded in an inter prediction mode, the prediction information may include a partition type of a prediction unit by inter prediction, a reference index, a motion vector, etc. When the image is encoded in an intra prediction mode, the prediction information may include information regarding a chroma component of the intra mode, information regarding an interpolation method of the intra mode, etc.

In operation S1125, the scalable video encoding apparatus 100 may encode the current data unit according to the prediction information.

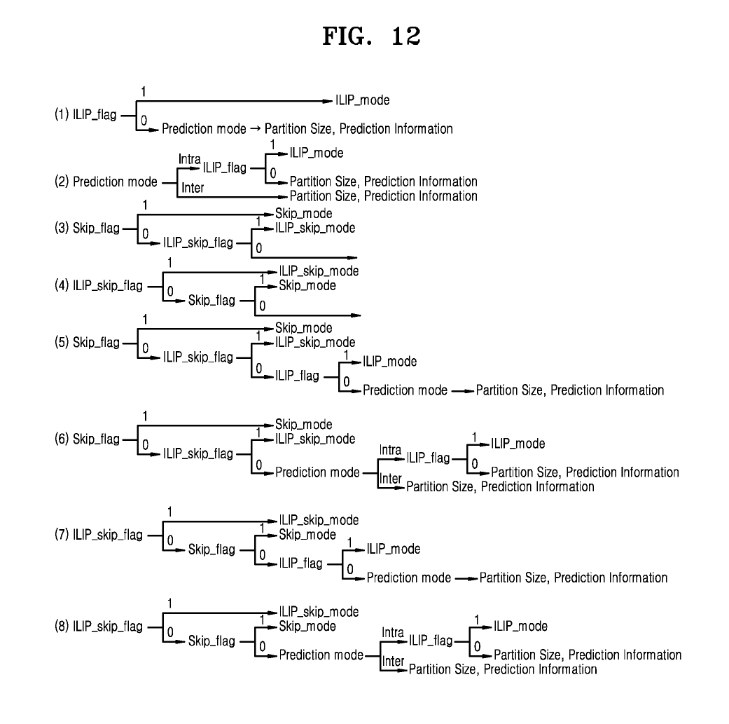

FIG. 12 is a diagram for explaining signaling of a flag or prediction information, according to an exemplary embodiment.

In signaling methods (1) and (2), a skip flag skip_flag and an inter-layer intra prediction skip flag ILIP_skip_flag are not signaled.

In the signaling method (1), an inter-layer intra prediction flag ILIP_flag may be signaled, and, when the inter-layer intra prediction flag ILIP_flag is 0, a prediction mode, a partition size, and prediction information may be signaled. The signaling method (1) may correspond to operation S1121 of FIG. 11 of signaling the inter-layer intra prediction flag ILIP_flag before signaling the prediction mode. The signaled prediction information may include prediction information that may be generated in an intra mode or the inter mode.

When the inter-layer intra prediction flag ILIP_flag is 1, encoding may be performed in an inter-layer intra prediction mode, and thus operations S1005 through S1015 of FIG. 10 may be performed.

In the signaling method (2) of first signaling the prediction mode, the inter-layer intra prediction flag ILIP_flag may be signaled only when the prediction mode is the intra mode. The signaling method (2) may correspond to operations S1109 and S1111 of FIG. 11 of signaling the inter-layer intra prediction flag ILIP_flag.

In the intra mode, a value of the inter-layer intra prediction flag ILIP_flag may be signaled, and, if the value of the inter-layer intra prediction flag ILIP_flag is 1, encoding may be performed in the inter-layer intra prediction mode, where the signaling method (2) may correspond to operation S1119 of FIG. 11, and operations S1005 through S1015 may be performed. If the value of the inter-layer intra prediction flag ILIP_flag is 0, prediction information including information regarding a chroma component of the intra mode, information regarding an interpolation method of the intra mode, a partition size, and a prediction mode may be signaled, and the signaling method (2) may correspond to operations S1113 and S1115 of FIG. 11.

In the inter mode, prediction information including a partition type of a prediction unit by inter prediction, a reference index, a motion vector, etc., a partition size, and a prediction mode may be signaled, and the signaling method (2) may correspond to operations S1111 and S1115 of FIG. 11.

In signaling methods (3) and (4), the skip flag skip_flag and an inter-layer intra prediction skip flag ILIP_skip_flag are signaled. A case where both the skip flag skip_flag and the inter-layer intra prediction skip flag ILIP_skip_flag are 0 is not defined. The case will be described with respect to signaling methods (5) through (8) below.

In the signaling method (3), the skip flag skip_flag may be first signaled, and, if the skip flag skip_flag is 1, encoding may be performed. The signaling method (3) may correspond to operation S1103 of FIG. 11. If the skip flag skip_flag is 0, the inter-layer intra prediction skip flag ILIP_skip_flag may be signaled, and, if the signaled inter-layer intra prediction skip flag ILIP_skip_flag is 1, encoding may be performed in an inter-layer intra prediction skip mode. The signaling method (3) may correspond to operations S1105 and S1107 of FIG. 11.

In the signaling method (4), the inter-layer intra prediction skip flag ILIP_skip_flag may be first signaled, and, if the inter-layer intra prediction skip flag ILIP_skip_flag is 1, encoding may be performed in the inter-layer intra prediction skip mode. If the inter-layer intra prediction skip flag ILIP_skip_flag is 0, the skip flag skip_flag may be signaled. If the signaled inter-layer intra prediction skip flag ILIP_skip_flag is 1, encoding may be performed in a skip mode.

Signaling methods (5) through (8) show a number of cases where the inter-layer intra prediction flag ILIP_flag is signaled when both the skip flag skip_flag and the inter-layer intra prediction skip flag ILIP_skip_flag are 0.

In signaling methods (5) through (7), the inter-layer intra prediction flag ILIP_flag is first signaled when both the flag skip_flag and the inter-layer intra prediction skip flag ILIP_skip_flag are 0, which is the same as the signaling method (1).

In the signaling methods (6) and (8), when both the flag skip_flag and the inter-layer intra prediction skip flag ILIP_skip_flag are 0, the prediction mode may be first signaled, and, in the intra mode, the inter-layer intra prediction flag ILIP_flag is signaled, which is the same as the signaling method (2).

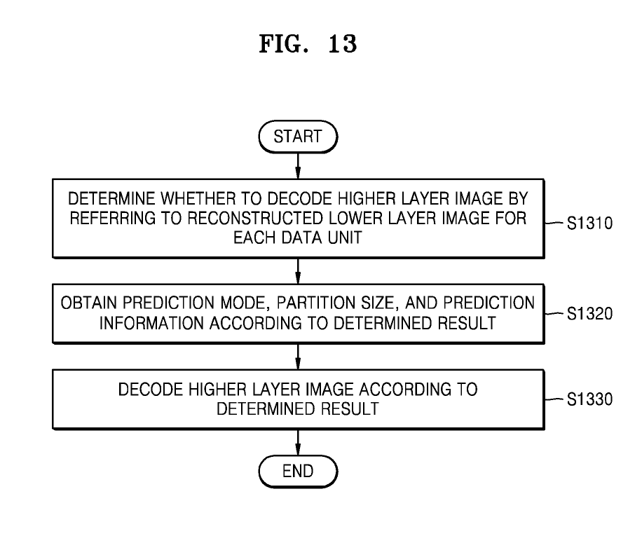

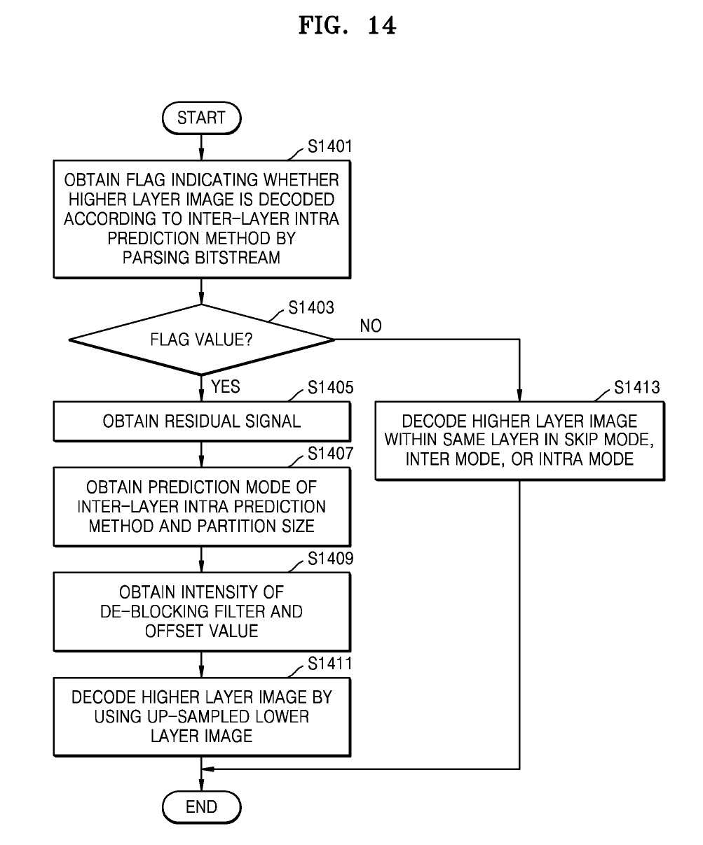

FIGS. 13 and 14 are flowcharts of a scalable video decoding method according to exemplary embodiments.

Referring to FIG. 13, in operation S1310, the scalable video decoding apparatus 200 may determine whether to decode a higher layer image by referring to a reconstructed lower layer image for each data unit by using flag information parsed from a bitstream. In particular, the scalable video decoding apparatus 200 may determine whether to decode the higher layer image according to an inter-layer intra prediction method or whether to decode the higher layer image in one of an inter mode, an intra mode, and a skip mode. The bitstream may include encoded data of an image output by the scalable video encoding apparatus 100.

In operation S1320, the scalable video decoding apparatus 200 may obtain prediction information according to a result determined in operation S1310. That is, when the scalable video decoding apparatus 200 decodes the higher layer image according to the inter-layer intra prediction method, the scalable video decoding apparatus 200 may not obtain the prediction information but may obtain prediction information when the scalable video decoding apparatus 200 does not decode the higher layer image according to the inter-layer intra prediction method.

The prediction information that may be obtained may include different information according to a prediction mode. In the inter mode, the prediction information may include a partition type of a prediction unit by inter prediction, a reference index, and a motion vector. In the intra mode, the prediction information may include a partition type of a prediction unit by intra prediction, information regarding a chroma component of the intra mode, or information regarding an interpolation method of the intra mode.

When the scalable video decoding apparatus 200 decodes the higher layer image according to the inter-layer intra prediction method, the scalable video decoding apparatus 200 may obtain information including a residual signal, the prediction mode, the partition size, the intensity of a de-blocking filter, an offset, and context model information that are encoded according to inter-layer intra prediction.

In operation S1330, the scalable video decoding apparatus 200 may decode the higher layer image according to the result determined in operation S1310. That is, when the scalable video decoding apparatus 200 decodes the higher layer image according to the inter-layer intra prediction method, the scalable video decoding apparatus 200 may decode the higher layer image by using the information encoded according to the inter-layer intra prediction obtained in operation S1320. When the scalable video decoding apparatus 200 decodes the higher layer image in one of the skip mode, the intra mode, and the inter mode other than the inter-layer intra prediction method, the scalable video decoding apparatus 200 may decode the higher layer image by using the prediction information obtained in operation S1320.

A scalable video decoding method based on a prediction method according to an exemplary embodiment will now be described in more detail with reference to FIG. 14.

Referring to FIG. 14, in operation S1401, the scalable video decoding apparatus 200 may obtain a flag indicating whether to decode a higher layer image by referring to a reconstructed lower layer image for each data unit. In particular, the scalable video decoding apparatus 200 may obtain a flag indicating whether to decode the higher layer image according to an inter-layer intra prediction method including an inter-layer intra prediction mode or an inter-layer intra prediction skip mode. When a flag value is 1, it is assumed that the higher layer image is decoded according to the inter-layer intra prediction method.

In operation S1403, the scalable video decoding apparatus 200 may decode the higher layer image according to the flag value obtained in operation S1401. That is, when the flag value is 1, the higher layer image may be decoded in operations S1405 through S1411 according to the inter-layer intra prediction method.

In operations S1405 through S1409, the scalable video decoding apparatus 200 may obtain a residual signal, a prediction mode of the inter-layer intra prediction method, a partition size, the intensity of a de-blocking filter, and an offset value from a parsed bitstream. The scalable video decoding apparatus 200 may decode the higher layer image of operation S1411 by using the information obtained in operations S1405 through S1409.

In more detail, the scalable video decoding apparatus 200 may obtain a prediction image by using the residual signal and an up-sampled lower layer image and may decode the higher layer image by using the obtained prediction image, the prediction mode, the partition size, and the prediction information. When the prediction mode is an inter mode, the prediction information may include a partition type of a prediction unit by inter prediction, a reference index, and a motion vector. When the prediction mode is an intra mode, the prediction information may include a partition type of a prediction unit by intra prediction, information regarding a chroma component of the intra mode, and information regarding an interpolation method of the intra mode. In this regard, the scalable video decoding apparatus 200 may decode the higher layer image according to the inter-layer intra prediction method for each data unit. For convenience of description, a description of an exemplary embodiment in which an image is decoded for each data unit is omitted.

When the scalable video decoding apparatus 200 performs decoding in an inter-layer intra prediction skip mode, the scalable video decoding apparatus 200 may perform decoding on the higher layer image by using the information obtained in operations S1405 through S1411 without obtaining the residual signal.

In more detail, the scalable video decoding apparatus 200 may obtain a prediction image by using the up-sampled lower layer image and decode the higher layer image by using the obtained prediction image and information regarding the prediction mode and the partition size. In this regard, the scalable video decoding apparatus 200 may decode the higher layer image in the inter-layer intra prediction skip mode for each data unit.

When the flag value is 0, in operation S1413, the scalable video decoding apparatus 200 may perform decoding on the higher layer image in a prediction mode other than the inter-layer intra prediction method. That is, the scalable video decoding apparatus 200 may decode the higher layer image in one of the skip mode, the inter mode, and the intra mode within the same layer as the higher layer image that is to be decoded by not referring to the higher layer image of another layer.

Also, although an inter-layer prediction mode is not particularly mentioned, the inter-layer prediction mode may be dealt with in the same manner as the inter-layer intra prediction method according to an exemplary embodiment.

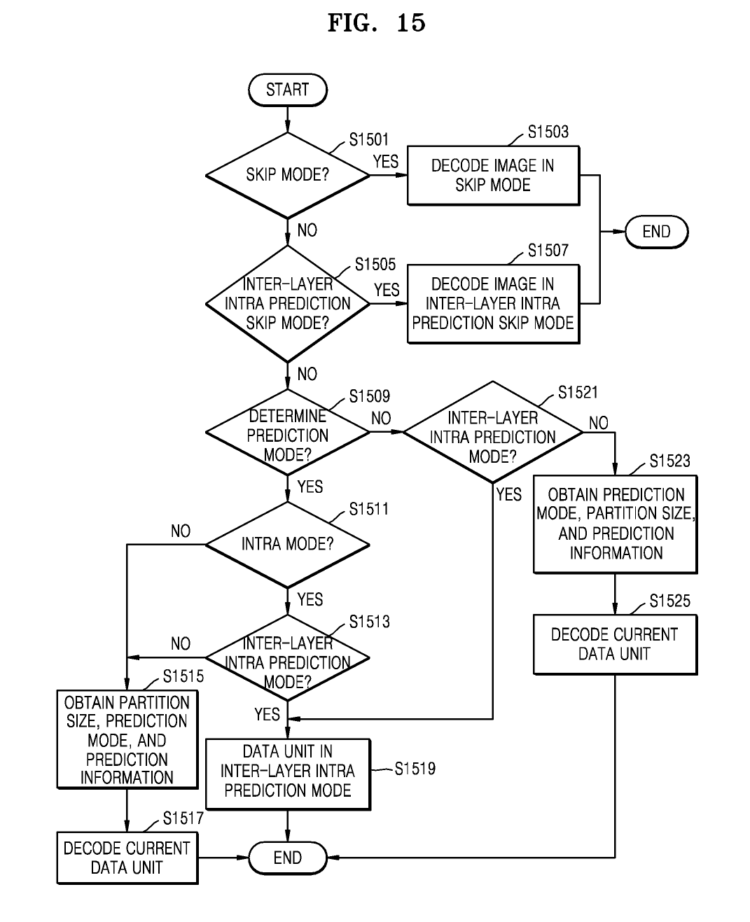

FIG. 15 is a flowchart of a method of obtaining a signaled flag or prediction information, according to an exemplary embodiment.

Referring to FIG. 15, in operation S1501, the scalable video decoding apparatus 200 may obtain a skip flag that is signaled for a data unit of an image that is to be decoded.

When the image is predicted in a skip mode in operation S1501, in operation S1503, the scalable video decoding apparatus 200 may decode the image in the skip mode. That is, the scalable video decoding apparatus 200 may not perform prediction in the skip mode but may decode the image or a partial region of the image by referring to a previous image. For example, the scalable video decoding apparatus 200 may determine each pixel value of the previous image as a pixel value of a position corresponding to each pixel value of the image so as to decode the image.

In operation S1505, the scalable video decoding apparatus 200 may obtain a signaled inter-layer intra prediction skip flag.

When the image is predicted and encoded in an inter-layer intra prediction skip mode in operation S1505, in operation S1507, the scalable video decoding apparatus 200 may predict and decode the image in the inter-layer intra prediction skip mode. That is, the scalable video decoding apparatus 200 may not obtain a residual signal between a lower layer image and a higher layer image in the inter-layer intra prediction skip mode but may decode the higher layer image or a partial region of the higher layer image by referring to the lower layer image.

Operation S1505 may be performed before operation S1501. That is, the scalable video decoding apparatus 200 may first obtain the inter-layer intra prediction skip flag before obtaining the skip flag.

According to whether the scalable video decoding apparatus 200 first signals a prediction mode or an inter-layer intra prediction flag in operation S1509, operation S1509 may branch to operation S1511 or S1521.

When the prediction mode is first signaled, in operation S1511, as an inter mode, in operation S1515, the scalable video decoding apparatus 200 may obtain a partition type of a prediction unit by inter prediction, a reference index, prediction information including a motion vector, and a partition size.

The scalable video decoding apparatus 200 may decode a current data unit in operation S1517 by using the prediction information obtained in operation S1515.

When the prediction mode is signaled as an intra mode in operation S1511, in operation S1513, the scalable video decoding apparatus 200 may obtain the inter-layer intra prediction flag. Although the inter-layer intra prediction flag is signaled in the intra mode according to an exemplary embodiment, the inter-layer intra prediction flag may alternatively be signaled in the inter mode according to a setting.

The scalable video decoding apparatus 200 may perform prediction and decoding in the intra mode when a flag value is 0, and thus, in operation S1515, the scalable video decoding apparatus 200 may obtain prediction information including information regarding a chroma component of the intra mode, information regarding an interpolation method of the intra mode, etc., and a partition size.

In operation S1517, the scalable video decoding apparatus 200 may decode a current data unit according to the prediction information.

When the scalable video decoding apparatus 200 decodes the image in the inter-layer intra prediction mode, in operation S1519, the scalable video decoding apparatus 200 may decode the current data unit in the inter-layer intra prediction mode. That is, the scalable video decoding apparatus 200 may decode a data unit of the higher layer image by referring to a data unit of the lower layer image.

When the inter-layer intra prediction flag is signaled before the prediction mode in operation S1509, in operation S1521, the scalable video decoding apparatus 200 may obtain the inter-layer intra prediction flag.

When the scalable video decoding apparatus 200 decodes the image in the inter-layer intra prediction mode, in operation S1519, the scalable video decoding apparatus 200 may decode the current data unit in the inter-layer intra prediction mode. That is, the scalable video decoding apparatus 200 may decode a data unit of the higher layer image by referring to a data unit of the lower layer image.

When the scalable video decoding apparatus 200 does not decode the image in the inter-layer intra prediction mode, in operation S1523, the scalable video decoding apparatus 200 may obtain a prediction mode, a partition size, and prediction information. When the image is decoded in an inter prediction mode, the prediction information may include a partition type of a prediction unit by inter prediction, a reference index, a motion vector, etc. When the image is decoded in an intra prediction mode, the prediction information may include information regarding a chroma component of the intra mode, information regarding an interpolation method of the intra mode, etc.

In operation S1525, the scalable video decoding apparatus 200 may decode the current data unit according to the prediction information.

The exemplary embodiments can be written as computer programs and can be implemented in general-use digital computers that execute the programs using a computer readable recording medium. Examples of the computer-readable recording medium include magnetic storage media (e.g., ROM, floppy disks, hard disks, etc.) and optical recording media (e.g., CD-ROMs, DVDs, etc.).

While the exemplary embodiments have been particularly shown and described with reference to certain exemplary embodiments thereof, it will be understood by those of ordinary skill in the art that various changes in form and details may be made therein without departing from the spirit and scope of the exemplary embodiments as defined by the appended claims. The exemplary embodiments should be considered in a descriptive sense only and not for purposes of limitation. Therefore, the scope of the exemplary embodiments is defined not by the detailed description of the exemplary embodiments but by the appended claims, and all differences within the scope will be construed as being included in the exemplary embodiments.

1. A scalable video encoding method comprising:
determining whether to encode a higher layer image by referring to a reconstructed lower layer image for a data unit, the reconstructed lower layer image being at a lower layer than the higher layer image;
adding a flag indicating whether to encode the higher layer image to an encoded bitstream of the higher layer image based on a result of the determining; and
determining whether to signal a prediction mode, a partition size, and prediction information based on a value of the flag.

2. The scalable video encoding method of claim 1, wherein the determining of whether to encode the higher layer image comprises: determining an inter-layer intra prediction method configured to predict and encode the higher layer image by referring to the reconstructed lower layer image, and
the scalable video encoding method further comprises:
setting the inter-layer intra prediction method as a part of an inter mode or an intra mode; and
generating and signaling prediction information to predict the higher layer image according to the inter-layer intra prediction method that is set as the part of the inter mode or the intra mode.

3. The scalable video encoding method of claim 1, further comprising: determining an intensity of a de-blocking filter of the data unit based on whether the data unit is encoded by referring to the reconstructed lower layer image.

4. The scalable video encoding method of claim 1, further comprising: determining a context model that is a probability model used to perform binary arithmetic encoding of a syntax element related to a current encoding block in the higher layer image based on a number of times the current encoding block is spatially split from a maximum coding unit.

5. The scalable video encoding method of claim 4, further comprising:
obtaining an offset value of a current coding unit;
up-sampling the reconstructed lower layer image including a region corresponding to the current coding unit;
shifting the region of the up-sampled lower layer image by using the obtained offset value;
obtaining a reconstructed lower layer image of the shifted region; and
encoding the current coding unit by referring to the obtained reconstructed lower layer image.

6. The scalable video encoding method of claim 1, further comprising:
generating a skip flag or an inter-layer intra prediction skip flag;
determining a signaling order of the generated skip flag or the generated inter-layer intra prediction skip flag;
adding the generated skip flag or the generated inter-layer intra prediction skip flag to the encoded bitstream of the higher layer image based on the determined signaling order; and
generating an inter-layer intra prediction flag and adding the generated inter-layer intra prediction flag to the encoded bitstream of the higher layer image based on a value of the generated inter-layer intra prediction flag.

7. A scalable video decoding method comprising:
obtaining a flag indicating whether to decode a higher layer image by referring to a reconstructed lower layer image for a data unit, the reconstructed lower layer image being at a lower layer than the higher layer image, so as to decode the higher layer image;
determining whether to decode the higher layer image based on a value of the obtained flag; and
decoding the higher layer image based on a result of the determining,
wherein the decoding of the higher layer image comprises obtaining a prediction mode, a partition size, and prediction information for the data unit based on the value of the obtained flag.

8. The scalable video decoding method of claim 7, wherein the determining of whether to decode the higher layer image comprises determining an inter-layer intra prediction method configured to predict and encode the higher layer image by referring to the reconstructed lower layer image based on the value of the obtained flag, and
wherein the decoding of the higher layer image comprises:
setting the inter-layer intra prediction method as a part of an inter mode or an intra mode; and
obtaining prediction information to predict the higher layer image according to the inter-layer intra prediction method that is set as the part of the inter mode or the intra mode.

9. The scalable video decoding method of claim 7, wherein the decoding of the higher layer image comprises determining an intensity of a de-blocking filter of the data unit based on whether to perform decoding on the data unit by referring to the reconstructed lower layer image.

10. The scalable video decoding method of claim 7, wherein the decoding of the higher layer image comprises determining a context model that is a probability model used to perform binary arithmetic encoding of a syntax element related to a current encoding block in the higher layer image based on a number of times the current encoding block is spatially split from a maximum coding unit.

11. The scalable video decoding method of claim 7, wherein the decoding of the higher layer image comprises:
obtaining an offset value of a current coding unit;
up-sampling the reconstructed lower layer image including a region corresponding to the current coding unit;
shifting the region of the up-sampled lower layer image by using the obtained offset value;
obtaining a reconstructed lower layer image of the shifted region; and
decoding the current coding unit by referring to the obtained reconstructed lower layer image.

12. The scalable video decoding method of claim 7, further comprising:
generating a skip flag or an inter-layer intra prediction skip flag; and
obtaining an inter-layer intra prediction flag based on a value of the obtained skip flag or the obtained inter-layer intra prediction skip flag,
wherein the determining of whether to decode the higher layer image comprises determining whether to decode the higher layer image based on a value of the obtained inter-layer intra prediction flag.

13. A scalable video encoding apparatus comprising:
a lower layer encoder configured to encode a lower layer image;
a higher layer encoder configured to determine whether to encode a higher layer image that is at a higher layer than the lower image by referring to a reconstructed lower layer image for a data unit and thereby generate a determination result, encode the higher layer image based on the determination result, add a flag indicating whether to encode the higher layer image to an encoded bitstream of the higher layer image based on the determination result, and determine whether to signal prediction information to predict between images of the same layer as the higher layer image for the data unit or prediction information to predict and encode within the higher layer image; and
an outputter configured to output encoded data of the lower layer image or the higher layer image, the generated flag, and the prediction information,
wherein the data unit comprises at least one of a maximum coding unit, a coding unit, and a prediction unit.

14. A scalable video decoding apparatus comprising:
a parser configured to parse a flag indicating whether to decode a higher layer image by referring to a reconstructed lower layer image for a data unit, the reconstructed lower layer image being at a lower layer than the higher layer image, and encode data of the reconstructed lower layer image from a received bitstream, so as to decode the higher layer image;
a lower layer decoder configured to decode the reconstructed lower layer image; and
a higher layer decoder configured to determine whether to decode the higher layer image by referring to the reconstructed lower layer image for the data unit based on a value of the parsed flag, and decode the higher layer image,
wherein the higher layer decoder is configured to obtain prediction information to predict between images of the same layer as the higher layer image for the data unit or prediction information to predict and encode within the higher layer image based on the value of the parsed flag.

15. A non-transitory computer-readable recording medium having recorded thereon a program which, when executed, causes a computer to perform the method of claim 7.
